(19) United States
(12) Patent Application Publication
(10) Pub. No.: US 2024/0250728 A1
(43) Pub. Date: Jul. 25, 2024

(54) PUCCH Reporting of Reciprocity-Based Type-II Codebook

(71) Applicant: Lenovo (Singapore) Pte. Ltd., New Tech Park (SG)

(72) Inventors: Ahmed Hindy, Aurora, IL (US); Vijay Nangia, Woodridge, IL (US)

(21) Appl. No.: 18/288,678

(22) PCT Filed: Apr. 29, 2022
(86) PCT No.: PCT/IB22/54005

§ 371 Date: Oct. 27, 2023

Related U.S. Application Data
(60) Provisional application No. 63/182,591, filed on Apr. 30, 2021.

(51) Int. Cl. H04B 7/06; H04L 5/00; H04W 72/21

(52) U.S. Cl. CPC H04B 7/0626; H04L 5/0051; H04L 5/0057; H04W 72/21

(57) ABSTRACT

Apparatuses, systems, and methods for PUCCH reporting of reciprocity-based type-II codebook are disclosed. One apparatus (1100) includes a transceiver (1125) that receives, from a network entity, a channel state information (“CSI”) reporting configuration comprising a codebook type associated with a precoding matrix and CSI reference signals over a set of CSI reference signal (“CSI-RS”) resources based on the CSI reporting configuration. The apparatus (1100) includes a processor (1105) that identifies a set of co-efficients associated with the codebook based on the received set of CSI-RS resources. The transceiver (1125) transmits a CSI report on a physical uplink control(“PUCCH”) or a physical uplink shared channel (“PUSCH”) and based on the codebook type, the CSI report comprising CSI and the set of coefficients, wherein to transmit the CSI report on the PUCCH is based on a value of a sub-configuration or the CSI reporting configuration.

This application claims the benefit of the U.S. Provisional Patent Application No. 63/182,591, entitled “PUCCH REPORTING OF RECIPROCITY-BASED TYPE-II CODEBOOK” and filed on Apr. 30, 2021, for Ahmed Hindy, et al., which is incorporated herein by reference.

### FIELD

The subject matter disclosed herein relates generally to wireless communications and more particularly relates to physical uplink control channel (“PUCCH”) reporting of reciprocity-based type-II codebook.

### BACKGROUND

For new radio (“NR”) Rel. 16 Type-II codebook, the number of Precoding Matrix Indicator (“PMI”) bits fed back from the User Equipment (“UE”) in the next-generation node-B (gNB) via Uplink Control Information (“UCI”) can be very large (>1000 bits at large bandwidth. In addition, the number of Channel State Information Reference Signals (“CSI-RS”) ports sent in the downlink channel to enable channel estimation at the user equipment can be large a well, leading to higher system complexity and loss of resources and higher system overhead for reference signaling. Thereby, further reduction of the PMI feedback bits and/or a reduction in the number of CSI-RS ports utilized is needed to improve efficiency.

A special case of the NR Rel. 16 Type-II codebook (dubbed port-selection codebook) has been discussed, in which the number of CSI-RS ports is reduced via applying an underlying spatial beamforming process. In addition, it has been discussed that the channel correlation between uplink and downlink channels can be exploited to reduce CSI feedback overhead, even in the Frequency-Division Duplexing (“FDD”) mode where the Uplink (“UL”)-Downlink (“DL”) carrier frequency spacing is not too large. Also, two issues may arise under DL channel estimation based on partial UL channel reciprocity under FDD mode. First, the UL channel estimated at the gNB may not be accurate due to conventional channel estimation issues that are well-known in the field of wireless communications, e.g., channel quantization and hardware impairments. Second, the channel may vary within the time between the transmission of the Sounding Reference Signals (“SRS”) for UL CSI acquisition and the transmission of the beamformed CDI-RSs.

### BRIEF SUMMARY

In one embodiment, a first apparatus includes a transceiver that receives, from a

network entity, a channel state information (“CSI”) reporting configuration comprising a codebook type associated with a precoding matrix. In one embodiment, the transceiver receives, from the network entity, CSI reference signals (“CSI-RS”) over a set of CSI-RS resources based on the CSI reporting configuration. In one embodiment, the apparatus includes a processor that identifies a set of coefficients associated with the codebook based on the received set of CSI-RS resources. In one embodiment, the transceiver transmits, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration.

In one embodiment, a first method includes receiving, from a network entity, a channel state information (“CSI”) reporting configuration comprising a codebook type associated with a precoding matrix. In one embodiment, the first method includes receiving, from the network entity, CSI reference signals (“CSI-RS”) over a set of CSI-RS resources based on the CSI reporting configuration. In one embodiment, the first method includes identifying a set of coefficients associated with the codebook based on the received set of CSI-RS resources. In one embodiment, the first method includes transmitting, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration.

In one embodiment, a second apparatus includes a transceiver that transmits, to a user equipment (“UE”), a channel state information (“CSI”) reporting configuration comprising a codebook type associated with a precoding matrix. In one embodiment, the transceiver transmits, to the UE, CSI reference signals (“CSI-RS”) over a set of CSI-RS resources based on the CSI reporting configuration. In one embodiment, the transceiver receives, from the UE, a CSI report on a physical uplink control channel (“PUCCH”) or a physical uplink shared channel (“PUSCH”) and based on the codebook type, the CSI report comprising CSI and a set of coefficients associated with the codebook, wherein to receive the CSI report on the PUCCH is based on a value of a sub-configuration of the CSI reporting configuration.

In one embodiment, a second method transmits, to a user equipment (“UE”), a channel state information (“CSI”) reporting configuration comprising a codebook type associated with a precoding matrix. In one embodiment, the second method transmits, to the UE, CSI reference signals (“CSI-RS”) over a set of CSI-RS resources based on the CSI reporting configuration. In one embodiment, the second method receives, from the UE, a CSI report on a physical uplink control channel (“PUCCH”) or a physical uplink shared channel (“PUSCH”) and based on the codebook type, the CSI report comprising CSI and a set of coefficients associated with the codebook, wherein to receive the CSI report on the PUCCH is based on a value of a sub-configuration of the CSI reporting configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for PUCCH reporting of reciprocity-based Type-II codebook;

FIG. 2 is a diagram illustrating one embodiment of Aperiodic Trigger State defining a list of CSI Report Settings;

FIG. 3 is a diagram illustrating one embodiment of Aperiodic trigger state indicates the resource set and QCL information;

FIG. 4 is a diagram illustrating one embodiment of RRC configuration for NZP-CSI-RS Resource;

FIG. 5 is a diagram illustrating one embodiment of RRC configuration for CSI-IM Resource;

FIG. 6 is a diagram illustrating one embodiment of Partial CSI omission for PUSCH-Based CSI;

FIG. 7 is a diagram illustrating one embodiment of ASN.1 code for configuring the UE with a PUCCH reporting of reciprocity-based Type-II codebook;

FIG. 8 is a diagram illustrating a second embodiment of ASN.1 code for configuring the UE with a PUCCH reporting of reciprocity-based Type-II codebook;

FIG. 9 is a diagram illustrating a third embodiment of ASN.1 code for configuring the UE with a PUCCH reporting of reciprocity-based Type-II codebook;

FIG. 10 is a diagram illustrating an example embodiment of ASN.1 code for CSI-RS-ResoureMapping CSI-RS resource mapping IE;

FIG. 11 is a block diagram illustrating one embodiment of a user equipment apparatus that may be used for codebook structure for PUCCH reporting of reciprocity-based Type-II codebook;

FIG. 12 is a block diagram illustrating one embodiment of a network apparatus that may be used for codebook structure for PUCCH reporting of reciprocity-based Type-II codebook;

FIG. 13 is a flowchart diagram illustrating one embodiment of a method for codebook structure for PUCCH reporting of reciprocity-based Type-II codebook; and

FIG. 14 is a flowchart diagram illustrating one embodiment of a method for codebook structure for PUCCH reporting of reciprocity-based Type-II codebook.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment.” “in an embodiment,” and similar language throughout this specification may, but do not necessarily, all refer to the same embodiment, but mean “one or more but not all embodiments” unless expressly specified otherwise. The terms “including.” “comprising,” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C.” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for codebook structure for PUCCH reporting of reciprocity-based Type-II codebook. For Third Generation Partnership Project (“3GPP”) New Radio (“NR”) Release 16 (“Rel-16”) Type-II codebook the number of Precoding Matrix Indicator (“PMI”) bits fed back from the User Equipment (“UE”) in the next-generation node-B (“gNB”) via Uplink Control Information (“UCI”) can be very large (>1000 bits at large bandwidth). In addition, the number of Channel State Information Reference Signals (“CSI-RS”) ports sent in the downlink channel to enable channel estimation at the user equipment can be large as well, leading to higher system complexity and loss of resources over reference signaling. Thereby, further reduction of the PMI feedback bits and/or a reduction in the number of CSI-RS ports utilized is needed to improve efficiency.

A special case of the NR Rel-16 Type-II codebook (dubbed port-selection codebook) was proposed, in which the number of CSI-RS ports was reduced via applying an underlying spatial beamforming process. No insight onto how to design this beamforming process was provided. In addition, it has been recently discussed in the literature that the channel correlation between uplink and downlink channels can be exploited to reduce Channel State Information (“CSI”) feedback overhead, even in the Frequency-Division Duplexing (“FDD”) mode where the Uplink-Downlink carrier frequency spacing is not too large. Also, two issues are expected to arise under Downlink (“DL”) channel estimation based on partial Uplink (“UL”) channel reciprocity under FDD mode. First, the UL channel estimated at the gNB (i.e., a 5G/NR Node B) may not be accurate due to conventional channel estimation issues that are well-known in the field of wireless communications, e.g., channel quantization and hardware impairments. Second, the channel may vary within the time between the transmission of the Sounding Reference Signals (“SRS”) for UL CSI acquisition and the transmission of the beamformed CSI-RSs.

In one embodiment, this disclosure provides details on the setup, conditions, and signaling variants under which Rel. 17 Type-II port-selection codebook. More specifically, the uplink channels that support transmission of Rel. 17 Type-II port selection are discussed, as well as the corresponding variants of the codebook for each channel. Moreover, the time-domain behavior of the Rel. 17 Type-II port selection codebook is also discussed.

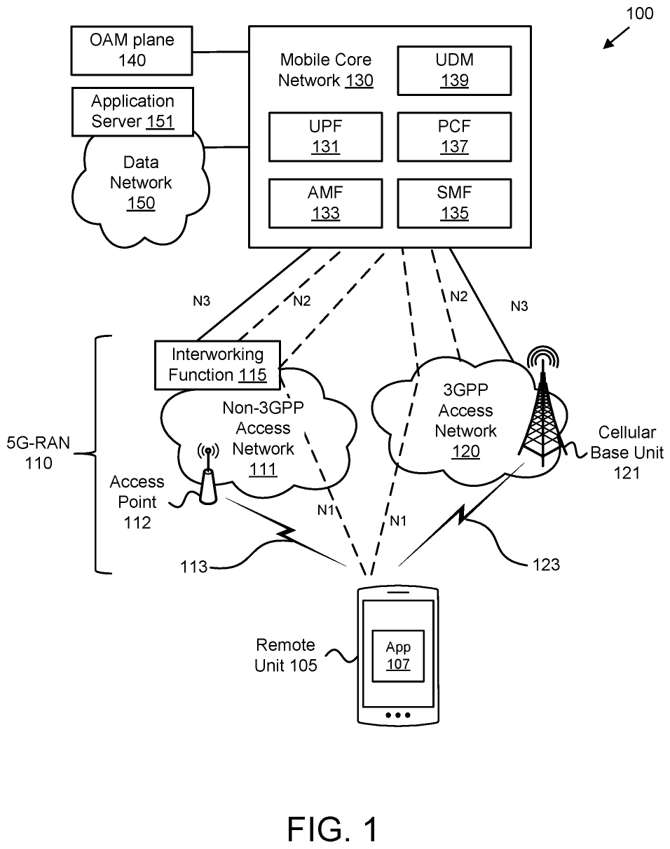

FIG. 1 depicts a wireless communication system 100 supporting PUCCH reporting of reciprocity-based Type-II codebook, according to embodiments of the disclosure. In one embodiment, the wireless communication system 100 includes at least one remote unit 105, a radio access network (“RAN”) 110 (e.g., a 5G RAN), and a mobile core network 130. The RAN 110 and the mobile core network 130 form a mobile communication network. The RAN 110 may be composed of a base unit 121. Even though a specific number of remote units 105, RANs 110, and mobile core networks 130 are depicted in FIG. 1, one of skill in the art will recognize that any number of remote units 105, RANs 110, and mobile core networks 130 may be included in the wireless communication system 100.

The 5G-(R)AN 110 may be composed of a Third Generation Partnership Project (“3GPP”) access network 120 containing at least one cellular base unit 121 and/or a non-3GPP access network 111 containing at least one access point 112. Here, the RAN 110 is an intermediate network that provides the remote units 105 with access to the mobile core network 130.

In one implementation, the 3GPP access network 120 that is compliant with the Fifth-Generation (“5G”) system specified in the 3GPP specifications. For example, the 3GPP access network 120 may be a New Generation Radio Access Network (“NG-RAN”), implementing NR Radio Access Technology (“RAT”) and/or 3GPP Long-Term Evolution (“LTE”) RAT. In another example, the 3GPP access network 120 may include non-3GPP RAT (e.g., Wi-Fi® or Institute of Electrical and Electronics Engineers (“IEEE”) 802.11-family compliant WLAN). In another implementation, the 3GPP access network 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with the base units 121 in the 3GPP access network 120 via uplink (“UL”) and/or downlink (“DL”) communication signals. Furthermore, the UL and DL communication signals may be carried over the 3GPP wireless communication links 123. Additionally (or alternatively), the remote units 105 may communicate directly with the access points 112 in the non-3GPP access network 111 via UL and/or DL communication signals, which may be carried over the non-3GPP communication links 113.

In some embodiments, the remote units 105 communicate with an application server 151 via a network connection with the mobile core network 130. For example, an application 107 (e.g., web browser, media client, email client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 110. The mobile core network 130 then relays traffic between the remote unit 105 and the application server 151 (e.g., a content server in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QOS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.c., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain

embodiments, a base unit 121 may also be referred to as an access terminal, an access point, a base, a base station, a Node-B (“NB”), an Evolved Node B (abbreviated as eNodeB or “CNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR in Unlicensed Spectrum (“NR-U”) operation, the base unit 121 and the remote unit 105 communicate over unlicensed radio spectrum.

The non-3GPP access networks 111 may be distributed over a geographic region. Each non-3GPP access network 111 may serve a number of remote units 105 with a serving area. Typically, a serving area of the non-3GPP access network 111 is smaller than the serving area of a cellular base unit 121. An access point 112 in a non-3GPP access network 111 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 112 may communicate using unlicensed radio spectrum. The mobile core network 140 may provide services to a remote unit 105 via the non-3GPP access networks 111, as described in greater detail herein.

In some embodiments, a non-3GPP access network 111 connects to the mobile core network 140 via an interworking function 115. The interworking function 115 provides interworking between the remote unit 105 and the mobile core network 140. In some embodiments, the interworking function 115 is a Non-3GPP Interworking Function (“N3IWF”) and, in other embodiments, it is a Trusted Non-3GPP Gateway Function (“TNGF”). The N3IWF supports the connection of “untrusted” non-3GPP access networks to the mobile core network (e.g., 5GC), whereas the TNGF supports the connection of “trusted” non-3GPP access networks to the mobile core network. The interworking function 115 supports connectivity to the mobile core network 140 via the “N2” and “N3” interfaces, and it relays “N1” signaling between the remote unit 105 and the AMF 143. As depicted, both the 3GPP access network 120 and the interworking function 115 communicate with the AMF 143 using a “N2” interface. The interworking function 115 also communicates with the UPF 141 using a “N3” interface.

In certain embodiments, a non-3GPP access network 111 may be controlled by an MNO of the mobile core network 140 and may have direct access to the mobile core network 140. Such a non-3GPP AN deployment is referred to as a “trusted non-3GPP access network.” A non-3GPP access network 111 is considered as “trusted” when it is operated by the MNO, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network.

In one embodiment, the mobile core network 130 is a 5G Core network (“5GC”) or an Evolved Packet Core network (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (DN), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The PCF 137 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

The Operations, Administration and Maintenance (“OAM”) plane 140 is involved with the operating, administering, managing and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM plane 140 may also be involved with provisioning, i.e., the setting up of the user accounts, devices and services.

While FIG. 1 depicts components of a 5G RAN and a 5G core network, the described embodiments apply to other types of communication networks and RATs, including IEEE 802.11 variants, Global System for Mobile Communications (“GSM,” i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR/5G BS, etc. Further the operations are described mainly in the context of 5G NR. However, the described solutions/methods are also equally applicable to other mobile communication systems supporting PUCCH reporting of reciprocity-based Type-II codebook. Regarding the 3GPP NR Rel-15 Type-II Codebook, it is assumed that the gNB is equipped with a two-dimensional (“2D”) antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁,N₂ CSI-RS ports are utilized to enable DL channel estimation with high resolution for NR Rel-15 Type-II codebook. In order to reduce the UL feedback overhead, a

Discrete Fourier transform (“DFT”)-based CSI compression of the spatial domain is applied to L dimensions per polarization, where L<N₁N₂. In the sequel the indices of the 2L dimensions are referred as the Spatial Domain (“SD”) basis indices. The magnitude and phase values of the linear combination coefficients for each sub-band are fed back to the gNB as part of the CSI report. The 2N₁N₂×N₃ codebook per layer takes on the form

$$W = {W}_{1} {W}_{2}$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} ⋯ {e}^{j \frac{2 π m ( {N}_{2} - 1 )}{{O}_{2} {N}_{2}}} ] \\ {v}_{l , m} = {[ {u}_{m} {e}^{j \frac{2 π l}{{O}_{2} {N}_{2}}} {u}_{m} ⋯ {e}^{j \frac{2 π l ( {N}_{1} - 1 )}{{O}_{2} {N}_{2}}} {u}_{m} ]}^{T} \\ B = [ {v}_{{l}_{0} , {m}_{0}} {v}_{{l}_{1} , {m}_{1}} ⋯ {v}_{{l}_{L - 1} , {m}_{L - 1}} ] \\ {l}_{i} = {O}_{1} {n}_{1}^{( i )} + {q}_{1} , 0 \leq {n}_{1}^{( i )} < {N}_{1} , 0 \leq {q}_{1} < {O}_{1} - 1 \\ {m}_{i} = {O}_{2} {n}_{2}^{( i )} + {q}_{2} , 0 \leq {n}_{2}^{( i )} < {N}_{2} , 0 \leq {q}_{2} < {O}_{2} - 1$$

where the superscript T denotes a matrix transposition operation. Note that O₁, O₂ oversampling factors are assumed for the 2D DFT matrix from which matrix B is drawn. Note that W₁ is common across all layers. W₂ is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W₂ are independent for different layers.

In more detail, the specification for the NR Rel. 15 Type-II Codebook is as follows (e.g., refer to 3GPP NR TS 38.214):

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII’
The values of N₁ and N₂ are configured with the higher layer parameter n1-n2-codebookSubsetRestriction. The supported configurations of (N₁, N₂) for a given number of CSI-RS ports and the corresponding values of (O₁, O₂) are given in Table 5.2.2.2.1-2 of TS 38.214. The number of CSI-RS ports, P_{CSI-RS}, is 2N₁N₂.
The value of L is configured with the higher layer parameter numberOfBeams, where L=2 when P_{CSI-RS-4}=4 and Lϵ{2,3,4} when P_{CSI-RS}>4.
The value of N_{PSK} is configured with the higher layer parameter phase AlphabetSize, where N_{PSK} ϵ{4,8}.
The UE is configured with the higher layer parameter subbandAmplitude set to ‘true’ or ‘false’.
The UE shall not report RI>2.

When v≤2, where v is the associated RI value, each PMI value corresponds to the codebook indices i₁ and i₂ where

$${i}_{1} = \{ \begin{matrix}[ {i}_{1 , 1} {i}_{1 , 2} {i}_{1 , 3 , 1} {i}_{1 , 4 , 1} ] & v = 1 \\ [ {i}_{1 , 1} {i}_{1 , 2} {i}_{1 , 3 , 1} {i}_{1 , 4 , 1} {i}_{1 , 3 , 2} {i}_{1 , 4 , 2} ] & v = 2\end{matrix} \\ {i}_{2} = \{ \begin{matrix}[ {i}_{2 , 1 , 1} ] & subbandAmplitude = ‘ false ’ , v = 1 \\ [ {i}_{2 , 1 , 1} {i}_{2 , 1 , 2} ] & subbandAmplitude = ‘ false ’ , v = 2 \\ [ {i}_{2 , 1 , 1} {i}_{2 , 2 , 1} ] & subbandAmplitude = ‘ true ’ , v = 1 \\ [ {i}_{2 , 1 , 1} {i}_{2 , 2 , 1} {i}_{2 , 1 , 2} {i}_{2 , 2 , 2} ] & subbandAmplitude = ‘ true ’ , v = 2\end{matrix} ..$$

The L vectors combined by the codebook are identified by the indices i_{1,1} and i_{1,2}, where

$${i}_{1 , 1} = [ {q}_{1} {q}_{2} ] \\ {q}_{1} ∈ \{ 0 , 1 , … , {O}_{1} - 1 \} \\ {q}_{2} ∈ \{ 0 , 1 , … , {O}_{2} - 1 \} \\ {i}_{1 , 2} ∈ \{ 0 , 1 , … , ( \begin{matrix}{N}_{1} {N}_{2} \\ L\end{matrix} ) - 1 \} .$$

$$Let$$

$${n}_{1} = [ {n}_{1}^{( 0 )} , … , {n}_{1}^{( L - 1 )} ] \\ {n}_{2} = [ {n}_{2}^{( 0 )} , … , {n}_{2}^{( L - 1 )} ] \\ {n}_{1}^{( i )} ∈ \{ 0 , 1 , … , {N}_{1} - 1 \} \\ {n}_{2}^{( i )} ∈ \{ 0 , 1 , … , {N}_{2} - 1 \}$$

$$and$$

$$C ( x , y ) = \{ \begin{matrix}( \begin{matrix}x \\ y\end{matrix} ) & x \geq y \\ 0 & x < y\end{matrix} .$$

where the values of C(x.y) are given in Table 1 below.

Then the elements of n₁ and n₂ are found from i_{1,2} using the algorithm:

$${s}_{- 1} = 0 for i = 0 , … , L - 1$$

Find the largest x*ϵ{L-1-i, . . . N₁N₂-1-i} in Table 1 such that i1,2-si-1≥C(x*,L-i)

$${e}_{i} = C ( {x}^{*} , L - i ) \\ {s}_{i} = {s}_{i - 1} + {e}_{i} \\ {n}^{( i )} = {N}_{1} {N}_{2} - 1 - {x}^{*} \\ {n}_{1}^{( i )} = {n}^{( i )} mod {N}_{1} \\ {n}_{2}^{( i )} = \frac{( {n}^{( i )} - {n}_{1}^{( i )} )}{{N}_{1}}$$

When n₁ and n₂ are known, i_{i,2} is found using:

$${n}_{( i )} = {N}_{1} {n}_{2} ( i ) + {n}_{1} ( i )$$

where the indices i=0,1, . . . , L-1 are assigned such that n⁽ⁱ⁾increases as i increases

$${i}_{1 , 2} = {\sum }_{i = 0}^{L - 1} C ( {N}_{1} {N}_{2} - 1 - {n}^{( i )} , L - i )$$

where C(x,y) is given in Table 1.
If N₂=1, q₂=0 and n₂⁽ⁱ⁾=0 for i=0,1, . . . , L-1, and q₂ is not reported.
When (N₁, N₂)=(2,1), n₁[0,1] and n₂=[0,0], and i_{1,2} is not reported.
When (N₁, N₂)=(4,1) and L=4, nᵢ=[0,1,2,3] and n₂=[0,0,0,0], and i_{1,2} is not reported.
When (N₁, N₂)=(2,2) and L=4, n₁=[0,1,0,1] and n₂=[0,0,1,1], and i_{1,2} is not reported.

TABLE 1
Combinatorial coefficients C(x, y)

y

| x | 1 | 2 | 3 | 4 |
|---|---|---|---|---|
| 0 | 0 | 0 | 0 | 0 |
| 1 | 1 | 0 | 0 | 0 |
| 2 | 2 | 1 | 0 | 0 |
| 3 | 3 | 3 | 1 | 0 |
| 4 | 4 | 6 | 4 | 1 |
| 5 | 5 | 10 | 10 | 5 |
| 6 | 6 | 15 | 20 | 15 |
| 7 | 7 | 21 | 35 | 35 |
| 8 | 8 | 28 | 56 | 70 |
| 9 | 9 | 36 | 84 | 126 |
| 10 | 10 | 45 | 120 | 210 |
| 11 | 11 | 55 | 165 | 330 |
| 12 | 12 | 66 | 220 | 495 |
| 13 | 13 | 78 | 286 | 715 |
| 14 | 14 | 91 | 364 | 1001 |
| 15 | 15 | 105 | 455 | 1365 |

The strongest coefficient on layer l=1, . . . , v is identified by i_{1,3,l}ϵ{0,1, . . . , 2L-1}. The amplitude coefficient indicators i_{1,4,l} and i_{2,2,l} are:

$${i}_{1 , 4 , l} = [ {k}_{l , 0}^{( 1 )} , {k}_{l , 1}^{( 1 )} , … , {k}_{l , 2 L - 1}^{( 1 )} ] \\ {i}_{2 , 2 , 1} = [ {k}_{l , 0}^{( 2 )} , {k}_{l , 1}^{( 2 )} , … , {k}_{l , 2 L - 1}^{( 2 )} ] \\ {k}_{l , i}^{( 1 )} ∈ \{ 0 , 1 , … \text{.7} \} \\ {k}_{l , i}^{( 2 )} ∈ \{ 0 , 1 \}$$

for l=1, . . . , v. The mapping from k_{l,i}⁽¹⁾ to the amplitude coefficient p_{i,l}⁽¹⁾ is given in Table 2 and the mapping from k_{l,i}⁽²⁾ to the amplitude coefficient p_{l,i}⁽²⁾ is given in Table 3. The amplitude coefficients are represented by

$${p}_{l}^{( 1 )} = [ {p}_{l , 0}^{( 1 )} , {p}_{l , 1}^{( 1 )} , … , {p}_{l , 2 L - 1}^{( 1 )} ] \\ {p}_{l}^{( 2 )} = [ {p}_{l , 0}^{( 2 )} , {p}_{l , 1}^{( 2 )} , … , {p}_{l , 2 L - 1}^{( 2 )} ]$$

$$for l = 1 , ⋯ , v .$$

TABLE 2
Mapping of elements of i_{1,4,l}: k_{l,i}⁽¹⁾ to p_{l,i}⁽¹⁾

| k_{l,i}⁽¹⁾ | p_{l,i}⁽¹⁾ |
|---|---|
| 0 | 0 |
| 1 | $\sqrt{\frac{1}{64}}$ |
| 2 | $\sqrt{\frac{1}{32}}$ |
| 3 | $\sqrt{\frac{1}{16}}$ |
| 4 | $\sqrt{\frac{1}{8}}$ |
| 5 | $\sqrt{\frac{1}{4}}$ |
| 6 | $\sqrt{\frac{1}{2}}$ |
| 7 | 1 |

TABLE 3
Mapping of elements of i_{2,2,l}: k_{l,i}⁽²⁾ to p_{l,i}⁽²⁾

| k_{l,i}⁽²⁾ | p_{l,i}⁽²⁾ |
|---|---|
| 0 | $\sqrt{\frac{1}{2}}$ |
| 1 | 1 |

The phase coefficient indicators are

i_{2,1,l}=[c_{i,0},c_{l,1}, . . . , c_{l,2L-1}]

for l=1, . . . , v.

The amplitude and phase coefficient indicators are reported as follows:
The indicators k_{l,i}_{_{1,3,l}}⁽¹⁾=7,k_{l,i}_{_{1,3,l}}⁽²⁾=1, and c_{l,i}_{_{1,3,l}}=0(l=1, . . . , v). k_{l,i}_{_{1,3,l}}⁽¹⁾, k_{1,3,l}⁽²⁾, and c_{1,i}_{_{1,3,l}} are not reported for l=1, . . . , v.
The remaining 2L-1 elements of i_{1,4,l}(l=1, . . . ,v) are reported, where k_{l,i}⁽¹⁾ϵ{0,1, . . . , 7}.
Let Mₗ(I=1, . . . ,v) be the number of elements of i_{1,4,l} that satisfy k_{l,i}⁽¹⁾>0.

The remaining 2L-1 elements of i_{2,1,l} and i_{2,2,l} (l=1, . . . , v) are reported as follows:
When subbandAmplitude is set to ‘false’,
   k_{l,i}⁽²⁾=1 for l=1, . . . , v, and i=0,1, . . . , 2L-1. i_{2,2,l} is not reported for l=1, . . . , v.
   For l=1, . . . , v, the elements of i_{2,1,l} corresponding to the coefficients that satisfy k_{l,i}⁽¹⁾>0, i≠i_{1,3,l}, as determined by the reported elements of i_{1,4,l}, are reported, where c_{o,i}ϵ{0,1, . . . , N_{PSK}-1} and the remaining 2L-Mₗ elements of i_{2,1,l} are not reported and are set to c_{l,i}=0.
When subbandAmplitude is set to ‘true’,
   For l=1, . . . , v, the elements of i_{2,2,l} and i_{2,2,l} corresponding to the min(Mₗ, K⁽²⁾)-1 strongest coefficients (excluding the strongest coefficient indicated by i_{1,3,l}), as determined by the corresponding reported elements of i_{1,4,l}, are reported, where k_{l,i}⁽²⁾ϵ{0,1} and c_{l,i}ϵ{0,1, . . . , N_{PSK}-1}. The values of K⁽²⁾ are given in Table 4. The remaining 2L-min(Mₗ, K⁽²⁾ elements of i_{2,2,l} are not reported and are set to k_{l,i}⁽²⁾=1. The elements of i_{2,1,l} corresponding to the Mₗ-min(Mₗ, K⁽²⁾) weakest non-zero coefficients are reported, where c_{l,i}ϵ{0,1,2,3}. The remaining 2L-Mₗ elements of i_{2,1,l} are not reported and are set to cₗ,i=0.
   When two elements, k_{l,x}⁽¹⁾ and k_{l,y}⁽¹⁾, of the reported elements of i_{1,4,l} are identical (k_{l,x}⁽¹⁾=k_{l,y}⁽¹⁾, then element min(x,y) is prioritized to be included in the set of the min(Mₗ, K⁽²⁾)-1 strongest coefficients for i_{2,1,l} and i_{2,2,l} (l=1, . . . , v) reporting.

TABLE 4
Full resolution sub-band coefficients
when subbandAmplitude is set to ‘true’

| L | K⁽²⁾ |
|---|---|
| 2 | 4 |
| 3 | 4 |
| 4 | 6 |

The codebooks for 1-2 layers are given in Table 5. where the indices m₁⁽ⁱ⁾ and m₂⁽ⁱ⁾ are given by:

$${m}_{1}^{( i )} = {O}_{1} {n}_{1}^{( i )} + {q}_{1} \\ {m}_{2}^{( i )} = {O}_{2} {n}_{2}^{( i )} + {q}_{2}$$

For i=0.1, . . . , L-1, and the quantities φ_{l,i}, uₘ, and v_{l,m} are given by

$${φ}_{l , i} = \{ \begin{matrix}{e}^{j 2 π {c}_{l , i} / {N}_{PSK}} & subbandAmplitude = ‘ false ’ \\ {e}^{j 2 π {c}_{l , i} / {N}_{PSK}} & subbandAmplitude = ‘ true ’ , min ( {M}_{l} , {K}^{( 2 )} ) strongest coefficients ( including {i}_{1 , 3 , l} ) with {k}_{l , i}^{( 1 )} > 0 \\ {e}^{j 2 π {c}_{l , i} / 4} & subbandAmplitude = ‘ true ’ , {M}_{l} - min ( {M}_{l} , {K}^{( 2 )} ) weakest coefficients with {k}_{l , i}^{( 1 )} > 0 \\ 1 & subbandAmplitude = ‘ true ’ , 2 L - {M}_{l} coefficients with {k}_{l , i}^{( 1 )} = 0\end{matrix} \\ {u}_{m} = \{ \begin{matrix}[ 1 {e}^{j \frac{2 π m}{{O}_{2} {N}_{2}}} ⋯ {e}^{j \frac{2 π m ( {N}_{2} - 1 )}{{O}_{2} {N}_{2}}} ] & {N}_{2} > 1 \\ 1 & {N}_{2} = 1\end{matrix} \\ {v}_{l , m} = {[ {u}_{m} {e}^{j \frac{2 π l}{{O}_{1} {N}_{1}}} {u}_{m} ⋯ {e}^{j \frac{2 π l ( {N}_{1} - 1 )}{{O}_{1} {N}_{1}}} {u}_{m} ]}^{T} .$$

TABLE 5
Codebook for 1-layer and 2-layer CSI reporting using antenna ports 3000 to 2999 + PCSI-RS

| Layers | |
|---|---|
| υ = 1 | W_{q}_{₁}_{,q}_{₂}_{,n}_{₁}_{,n}_{₂}_{,p}_{₁}_{⁽¹⁾}_{,p}_{₁}_{⁽²⁾}_{,i}_{_{2,1,1}}⁽¹⁾ = W_{q}_{₁}_{,q}_{₂}_{,n}_{₁}_{,n}_{₂}_{,p}_{₁}_{⁽¹⁾}_{,p}_{₁}_{⁽²⁾}_{,i}_{_{2,1,1}}¹ |
| υ = 2 | ${W}_{{q}_{1} , {q}_{2} , {n}_{1} , {n}_{2} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ {W}_{{q}_{1} , {q}_{2} , {n}_{1} , {n}_{2} , {p}_{1}^{( 1 )} , {p}_{1}^{( 2 )} , {i}_{2 , 1 , 1}}^{1} {W}_{{q}_{1} , {q}_{2} , {n}_{1} , {n}_{2} , {p}_{2}^{( 1 )} , {p}_{2}^{( 2 )} , {i}_{2 , 1 , 2}}^{2} ]$ |

where
${W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {{Σ}_{i = 0}^{2 L - 1} ( {p}_{l , i}^{( 1 )} {p}_{l , i}^{( 2 )} )}^{2}}} [ \begin{matrix}{Σ}_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {Σ}_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1 , 2 ,$
and the mappings from i₁ to q₁, q₂, n₁, n₂, p₁⁽¹⁾, and p₂⁽¹⁾, and from i₂ to i_{2,1,1}, i_{2,1,2}, p₁⁽²⁾ and p₂⁽²⁾
are as described above, including the ranges of the constituent indices of i₁ and i₂.

When the UE is configured with higher layer parameter codebookType set to ‘typeII’, the bitmap parameter typeII-RI-Restriction forms the bit sequence r₁, r₀ where r₀ is the LSB and r₁ is the MSB. When rᵢ is zero, iϵ{0,1}, PMI and RI reporting are not allowed to correspond to any precoder associated with v=i+1 layers. The bitmap parameter n1-n2-codebookSubsetRestriction forms the bit sequence B=B₁B₂ where bit sequences B₁, and B₂ are concatenated to form B. To define B₁ and B₂, first define the O₁O₂ vector groups G(r₁,r₂) as

$$G ( {r}_{1} , {r}_{2} ) = \{ {v}_{{N}_{1} {r}_{1} + {x}_{1} , {N}_{2} {r}_{2} + {x}_{2}} : {x}_{1} = 0 , 1 , … , {N}_{1} - 1 ; {x}_{2} = 0 , 1 , … , {N}_{2} - 1 \}$$

$$for$$

$${r}_{1} ∈ \{ 0 , 1 , … , {O}_{1} - 1 \} \\ {r}_{2} ∈ \{ 0 , 1 , … , {O}_{2} - 1 \}$$

The UE shall be configured with restrictions for 4 vector groups indicated by (r₁^{(k)},r₂^{(k)}) for k=0,1,2,3 and identified by the group indices

$${g}^{( k )} = {O}_{1} {r}_{2}^{( k )} + {r}_{1}^{( k )}$$

For k=0,1, . . . , 3, where the indices are assigned such that g^{(k)} increases as k increases. The remaining vector groups are not restricted.
If N₂=1, g^{(k)}=k for k=0,1, . . . , 3, and B₁ is empty.
If N₂>1, B₁=b₁⁽¹⁰⁾ . . . b₁⁽⁰⁾ is the binary representation of the integer β₁ where b₁⁽¹⁰⁾ is the MSB and b₁⁽⁰⁾ is the LSB. β₁ is found using:

$${β}_{1} = {\sum }_{k = 0}^{3} C ( {O}_{1} {O}_{2} - 1 - {g}^{( k )} , 4 - k ) ,$$

where C(x,y) is defined in Table 1.

The group indices g(k) and indicators (r₁^{(k)},r₂^{(k)} for k=0,1,2,3 may be found from β₁ using the algorithm:

$${s}_{- 1} = 0$$

for k=0, . . . ,3. Find the largest x* ϵ{3-k, . . . , O₁O₂-1-k} such that β₁-sₖ₋₁≥C(x*,4-k)

$${e}_{k} = C ( {x}^{*} , 4 - k ) \\ {s}_{k} = {s}_{k - 1} + {e}_{k} \\ {g}^{( k )} = {O}_{1} {O}_{2} - 1 - {x}^{*} \\ {r}_{1}^{( k )} = {g}^{( k )} mod {O}_{1} \\ {r}_{2}^{( k )} = \frac{( {g}^{( k )} - {r}_{1}^{( k )} )}{{O}_{1}}$$

The bit sequence B₂=B₂⁽⁰⁾B₂⁽¹⁾B₂⁽²⁾B₂⁽³⁾ is the concatenation of the bit sequences B₂^{(k)} for k=0,1, . . . , 3, corresponding to the group indices g^{(k)}. The bit sequence B₂^{(k)} is defined as

$${B}_{2}^{( k )} = {b}_{2}^{( k , 2 {N}_{1} {N}_{2} - 1 )} ⋯ {b}_{2}^{( k , 0 )}$$

Bits b₂^{(k,2(N}^{₁}^{x}^{₂}^{+x}^{₁}⁾b₂^{(k,2(N}^{₁}^{x}^{₂}^{+x}^{₁}⁾⁾ indicate the maximum allowed amplitude coefficient p_{i,j}⁽¹⁾ for the vector in group g^{(k)} indexed by x₁,x₂, where the maximum amplitude coefficients are given in Table 6. A UE that does not report parameter amplitudeSubsetRestriction=‘supported’ in its capability signaling is not expected to be configured with b₂^{(k,2(N}^{₁}^{x}^{₂}^{+x}^{₁}⁾⁺¹b₂^{(k,2(N}^{₁}^{x}^{₂}^{+x}^{₁}⁾⁾=01 or 10.

TABLE 6
Maximum allowed amplitude coefficients for restricted vectors

| Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ | Maximum Amplitude Coefficient p_{l,i}⁽¹⁾ |
|---|---|
| 00 | 0 |
| 01 | $\sqrt{\frac{1}{4}}$ |
| 10 | $\sqrt{\frac{1}{2}}$ |
| 11 | 1 |

Regarding 3GPP NR Rel-15, for Type-II Port Selection codebook, only K (where K≤2N₁N₂) beamformed CSI-RS ports are utilized in DL transmission, in order to reduce complexity. The. The K×N₃ codebook matrix per layer takes on the form:

$$W = {W}_{1}^{PS} {W}_{2}$$

Here, W₂ follows the same structure as the conventional NR Rel-15 Type-II Codebook, and are layer specific. W₁^{PS} is a K×2L block-diagonal matrix with two identical diagonal blocks, e.g.,

$${W}_{1}^{PS} = [ \begin{matrix}E & 0 \\ 0 & E\end{matrix} ] ,$$

and E is an K/2×L matrix whose columns are standard unit vectors, as follows:

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} … {e}_{mod ( {m}_{PS} {d}_{PS} + L - 1 , K / 2 )}^{( K / 2 )} ] ,$$

where eᵢ^{(K)} is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{L}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ]$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In more detail, the specification for the NR Rel. 15 Type-II Port Selection Codebook is as follows (see, e.g., 3GPP NR TS 38.214):

For 4 antenna ports {3000, 3001, . . . , 3003}, 8 antenna ports { 3000, 3001, . . . , 3007}, 12 antenna ports {3000, 3001, . . . , 3011}, 16 antenna ports { 3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection’
The number of CSI-RS ports is given by P_{CSI-RS} ϵ{4,8,12,16,24,32} as configured by higher layer parameter nrofPorts.
The value of L is configured with the higher layer parameter numberOfBeams, where L=2 when P_{CSI-RS}=4 and Lϵ{2,3,4} when P_{CSI-RS}>4.
The value of d is configured with the higher layer parameter portSelectionSamplingSize, where dϵ{1,2,3,4} and

$$d \leq min ( \frac{{P}_{CSI - RS}}{2} , L ) .$$

The value of N_{PSK} is configured with the higher layer parameter phase AlphabetSize, where N_{PSK}ϵ{4,8}.
The UE is configured with the higher layer parameter subbandAmplitude set to ‘true’ or ‘false’.
The UE shall not report RI>2.

The UE is also configured with the higher layer parameter type II-PortSelectionRI-Restriction. The bitmap parameter typell-PortSelectionRI-Restriction forms the bit sequence r₁,r₀ where r₀ is the LSB and r₁ is the MSB. When r₁ is zero, iϵ{0,1}, PMI and RI reporting are not allowed to correspond to any precoder associated with v=i+1 layers.

When v≤2, where v is the associated RI value, each PMI value corresponds to the codebook indices i₁ and i₂ where

$${i}_{1} = \{ \begin{matrix}[ {i}_{1 , 1} {i}_{1 , 3 , 1} {i}_{1 , 4 , 1} ] & v = 1 \\ [ {i}_{1 , 1} {i}_{1 , 3 , 1} {i}_{1 , 4 , 1} {i}_{1 , 3 , 2} {i}_{1 , 4 , 2} ] & v = 2\end{matrix} \\ {i}_{2} = \{ \begin{matrix}[ {i}_{2 , 1 , 1} ] & subbandAmplitude = ‘ false ’ , v = 1 \\ [ {i}_{2 , 1 , 1} {i}_{2 , 1 , 2} ] & subbandAmplitude = ‘ false ’ , v = 2 \\ [ {i}_{2 , 1 , 1} {i}_{2 , 2 , 1} ] & subbandAmplitude = ‘ true ’ , v = 1 \\ [ {i}_{2 , 1 , 1} {i}_{2 , 2 , 1} {i}_{2 , 1 , 2} {i}_{2 , 2 , 2} ] & subbandAmplitude = ‘ true ’ , v = 2\end{matrix}$$

The L antenna ports per polarization are selected by the index i_{1,1}, where

$${i}_{1 , 1} ∈ \{ 0 , 1 , … , ⌈ \frac{{P}_{CSI - RS}}{2} ⌉ - 1 \} .$$

The strongest coefficient on layer l, l=1, . . . , v is identified by i_{1,3,l}ϵ{0,1, . . . , 2L-1}.

The amplitude coefficient indicators i_{1,4,l} and i_{2,2,l} are

$${i}_{1 , 4 , l} = [ {k}_{l , 0}^{( 1 )} , {k}_{l , 1}^{( 1 )} , … , {k}_{l , 2 L - 1}^{( 1 )} ] \\ {i}_{2 , 2 , l} = [ {k}_{l , 0}^{( 2 )} , {k}_{l , 1}^{( 2 )} , … , {k}_{l , 2 L - 1}^{( 2 )} ] \\ {k}_{l , i}^{( 1 )} ∈ \{ 0 , 1 , … , 7 \} \\ {k}_{l , i}^{( 2 )} ∈ \{ 0 , 1 \}$$

for l=1, . . . , v. The mapping from k_{l,i}⁽¹⁾ to the amplitude coefficient p_{l,i}⁽¹⁾ is given in Table 2 and the mapping from k_{l,i}⁽²⁾ to the amplitude coefficient p_{l,i}⁽²⁾ is given in Table 3. The amplitude coefficients are represented by

$${p}_{l}^{( 1 )} = [ {p}_{l , 0}^{( 1 )} , {p}_{l , 1}^{( 1 )} , … , {p}_{l , 2 L - 1}^{( 1 )} ] \\ {p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . , v.

The phase coefficient indicators are

$${i}_{2 , 1 , l} = [ {c}_{l , 0} , {c}_{l , 1} , … , {c}_{l , 2 L - 1} ]$$

for l=1, . . . , v.

The amplitude and phase coefficient indicators are reported as follows:
The indicators k_{l,i}_{_{1,3,l}}⁽¹⁾=7, k_{l,i}_{_{1,3,l}}⁽²⁾−1, and c_{l,i}_{_{1,3,l}}=0(l=1, . . . , u). k_{l,i}_{_{1,3,l}}⁽¹⁾, k_{l,i}_{_{1,3,l}}⁽²⁾, and c_{l,i}_{_{1,3,l}} are not reported for 1=1, . . . , V.
The remaining 2L-1 elements of i_{1,3,l} (l=1, . . . , v) are reported, where k_{l,i}⁽⁾ϵ{0,1, . . . , 7}. Let Mₗ(l=1, . . . , v) be the number of elements of i_{1,4,l} that satisfy k_{l,i}⁽¹⁾>0.
The remaining 2L-1 elements of i_{2,1,l} and i_{2,2,l} (l=1, . . . , v) are reported as follows:
   When subbandAmplitude is set to ‘false’,
   k_{l,i}⁽²⁾=1 for l=1, . . . , u, and i=0, 1, . . . ,2L-1. i_{2,2,l} is not reported for l=1, . . . , v.
   For l=1, . . . , v, the Mₗ-1 elements of i_{2,1,l} corresponding to the coefficients that satisfy k_{i,l}⁽¹⁾>0, i≠i_{1,3,l}, as determined by the reported elements of i_{1,4,l}, are reported, where c_{l,i} ϵ{0,1, . . . , N_{PSK}-1} and the remaining 2L-Mₗ elements of i_{2,1,l} are not reported and are set to c_{l,i}=0.
When subbandAmplitude is set to ‘true’,
   For l=1, . . . , v, the elements of i_{2,2,l} and i_{2,1,l} corresponding to the min(MₗK⁽²⁾)-1 strongest coefficients (excluding the strongest coefficient indicated by i_{1,3,l}), as determined by the corresponding reported elements of i_{1,4,l}, are reported, where k_{l,i}⁽²⁾ϵ{0,1} and c_{l,i}ϵ{0,1, . . . ,N_{PSK}-1}. The values of K⁽²⁾ are given in Table 4. The remaining 2L- min(Mₗ,K⁽²⁾) elements of i_{2,2,l} are not reported and are set to k_{l,i}⁽²⁾=1. The elements of i_{2,1,l} corresponding to the Mₗ-min(Mₗ,K⁽²⁾) weakest non-zero coefficients are reported, where c_{l,i}ϵ{0,1,2,3}. The remaining 2L-Mₗ elements of i_{2,1,l} are not reported and are set to c_{l,i}=0.
   When two elements, k_{i,x}⁽¹⁾ and k_{l,y}⁽¹⁾, of the reported elements of i_{1,4,l} are identical (k_{l,x}⁽¹⁾=k_{l,y}⁽¹⁾), then element min(x,y) is prioritized to be included in the set of the min(Mₗ,K⁽²⁾)-1 strongest coefficients for i_{2,1,l} and i_{2.2.l} (l=1, . . . , v) reporting.

The codebooks for 1-2 layers are given in Table 7, where the quantity φ_{l,i} is given by

$${φ}_{l , i} = \{ \begin{matrix}{e}^{j \frac{2 π {c}_{l , i}}{{N}_{PSK}}} & subbandAmplitude = ‘ false ’ \\ {e}^{j \frac{2 π {c}_{l , i}}{{N}_{PSK}}} & subbandAmplitude = ‘ true ’ , min ( {M}_{l} , {K}^{( 2 )} ) strongest coefficients ( including {i}_{1 , 3 , l} ) with {k}_{l , i}^{( 1 )} > 0 \\ {e}^{j \frac{2 π {c}_{l , i}}{4}} & subbandAmplitude = ‘ true ’ , {M}_{l} - min ( {M}_{l} , {K}^{( 2 )} ) weakest coefficients with {k}_{l , i}^{( 1 )} > 0 \\ 1 & subbandAmplitude = ‘ true ’ , 2 L - {M}_{l} coefficients with {k}_{l , i}^{( )} = 0\end{matrix}$$

and vₘ is a P_{CSI-RS}/2-element column vector containing a value of 1 in element (m mod P_{CSI-RS}/2) and zeros elsewhere (where the first element is element 0).

TABLE 7
Codebook for 1-layer and 2-layer CSI reporting using antenna ports 3000 to 2999 + P_{CSI-RS}

| Layers | |
|---|---|
| υ = 1 | Wᵢ_{_{1,1}}_{,p}_{₁}_{⁽¹⁾}_{,p}_{₁}_{⁽²⁾}_{,i}_{_{2,1,1}}⁽¹⁾ = Wᵢ_{_{1,1}}_{,p}_{₁}_{⁽¹⁾}_{,p}_{₁}_{⁽²⁾}_{,i}_{_{2,1,1}}¹ |
| υ = 2 | ${W}_{{i}_{1 , 1} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ {W}_{{i}_{1 , 1} , {p}_{1}^{( 1 )} , {p}_{1}^{( 2 )} , {i}_{2 , 1 , 1}}^{1} {W}_{{i}_{1 , 1} , {p}_{2}^{( 1 )} , {p}_{2}^{( 2 )} , {i}_{2 , 1 , 2}}^{2} ]$ |

where

${W}_{{i}_{1 , 1} , {p}_{l}^{( 1 )} , {p}_{l}^{( 2 )} , {i}_{2 , 1 , l}}^{l} = \frac{1}{\sqrt{{{Σ}_{i = 0}^{2 L - 1} ( {p}_{l , i}^{( 1 )} {p}_{l , i}^{( 2 )} )}^{2}}} [ \begin{matrix}{Σ}_{i = 0}^{L - 1} {v}_{{i}_{1 , 1} , d + i} {p}_{l , i}^{( 1 )} {p}_{l , i}^{( 2 )} {φ}_{l , i} \\ {Σ}_{i = 0}^{L - 1} {v}_{{i}_{1 , 1} , d + i} {p}_{l , i + L}^{( 1 )} {p}_{l , i + L}^{( 2 )} {φ}_{l , i + L}\end{matrix} ] , l = 1 , 2 ,$

and the mappings from i₁ to i_{1,1}, p₁⁽¹⁾, and p₂⁽¹⁾ and from i₂ to i_{2,1,1}, i_{2,1,2}, p₁⁽²⁾, and p₂⁽²⁾
are as described above, including the ranges of the constituent indices of i₁ and i₂.

Regarding 3GPP NR Rel-15, the Type-I codebook is the baseline codebook for NR, with a variety of configurations. The most common utility of Rel. 15 Type-I codebook is a special case of NR Rel. 15 Type-II codebook with L=1 for RI=1,2, wherein a phase coupling value is reported for each sub-band, i.e., W₂ is 2×N₃, with the first row equal to [1, 1, . . . , 1] and the second row equal to [e^{j2π∅}^{₀}, . . . , e^{j2π∅}^{_{N3-1}}]. Under specific configurations, ϕ₀=ϕ₁ . . . =φ, i.e., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

Regarding the 3GPP NR Rel-16 Type-II Codebook, it is assumed that the gNB is equipped with a two-dimensional (2D) antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂N₃ codebook per layer takes on the form:

$$W = {W}_{1} {\tilde{W}}_{2} {W}_{f}^{H}$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} ⋯ {e}^{j \frac{2 π m ( {N}_{2} - 1 )}{{O}_{2} {N}_{2}}} ] , \\ {v}_{l , m} = {[ {u}_{m} {e}^{j \frac{2 π l}{{O}_{1} {N}_{1}}} {u}_{m} ⋯ {e}^{j \frac{2 π l ( {N}_{1} - 1 )}{{O}_{1} {N}_{1}}} {u}_{m} ]}^{T} , \\ B = [ {v}_{{l}_{0} , {m}_{0}} {v}_{{l}_{1} , {m}_{1}} ⋯ {v}_{{l}_{L - 1} , {m}_{L - 1}} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} - 1 , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} - 1$$

where the superscript T denotes a matrix transposition operation. Note that O₁, O₂ oversampling factors are assumed for the 2D DFT matrix from which matrix B is drawn. Note that W₁ is common across all layers. In various embodiments, the above parameters comply with 3GPP TS 38.214 definitions and procedures. W_{f} is an N₃×M matrix (where M<N₃) with columns selected from a critically-sampled size-N₃ DFT matrix, as follows:

$${W}_{f} = [ {f}_{{k}_{0}} {f}_{{k}_{1}} ⋯ {f}_{{k}_{M ′ - 1}} ] , 0 \leq {k}_{i} < {N}_{3} - 1 \\ {f}_{k} = {[ 1 {e}^{- j \frac{2 π k}{{N}_{3}}} ⋯ {e}^{- j \frac{2 π k ( {N}_{3} - 1 )}{{N}_{3}}} ]}^{T}$$

Only the indices of the L selected columns of B are reported, along with the oversampling index taking on O₁O₂ values. Similarly for W_{F}, only the indices of the M selected columns out of the predefined size-N₃ DFT matrix are reported. In the sequel the indices of the M dimensions are referred as the selected Frequency Domain (“FD”) basis indices. Hence, L, M represent the equivalent spatial and frequency dimensions after compression, respectively. Finally, the 2L×M matrix \tilde{W}₂ represents the linear combination coefficients (“LCCs”) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of ┌2βLM┐-1 coefficients (along with the indices of selected L, M DFT vectors) are reported per layer, leading to significant reduction in CSI report size, compared with reporting 2N₁N₂×N₃-1 coefficients' information.

In more detail, the specification for the NR Rel. 16 Type-II Codebook is as follows (e.g., see 3GPP NR TS 38.214):

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and UE configured with higher layer parameter codebookType set to ‘typeII-r16’
The values of N₁ and N₂ are configured with the higher layer parameter n1-n2-codebookSubsetRestriction-r16. The supported configurations of (N₁, N₂) for a given number of CSI-RS ports and the corresponding values of (O₁, O₂) are given in Table 5.2.2.2.1-2 of TS 38.214. The number of CSI-RS ports, P_{CSI-RS}, is 2N₁N₂.
The values of L, βand pᵥ are determined by the higher layer parameter paramCombination-r16, where the mapping is given in Table 8.
The UE is not expected to be configured with paramCombination-r16 equal to
   3, 4, 5, 6, 7, or 8 when PCSI-RS=4,
   7 or 8 when P_{CSI-RS}<32
   7 or 8 when higher layer parameter typeII-RI-Restriction-r16 is configured with rᵢ=1 for any i>1.
   7 or 8 when R=2.

The parameter R is configured with the higher-layer parameter numberOfPMISubbandsPerCQISubband-r16. This parameter controls the total number of precoding matrices N₃ indicated by the PMI as a function of the number of configured subbands in csi-ReportingBand, the subband size configured by the higher-level parameter subbandSize and of the total number of PRBs in the bandwidth part according to Table 5.2.1.4-2 of TS 38.214, as follows:
When R=1:
   One precoding matrix is indicated by the PMI for each sub-band in csi-ReportingBand.
When R=2:
   For each sub-band in csi-ReportingBand that is not the first or last sub-band of a BWP, two precoding matrices are indicated by the PMI: the first precoding matrix corresponds to the first N_{PRB}^{SB}/2 PRBs of the subband and the second precoding matrix corresponds to the last N_{PRB}^{SB}/2 PRBs of the subband.
   For each sub-band in csi-ReportingBand that is the first or last sub-band of a BWP.
      If

$$( {N}_{BWP , i}^{start} mod {N}_{PRB}^{SB} ) \geq \frac{{N}_{PRB}^{SB}}{2} ,$$

one precoding matrix is indicated by the PMI corresponding to the first sub-band. If

$$( {N}_{BWP , i}^{start} mod {N}_{PRB}^{SB} ) < \frac{{N}_{PRB}^{SB}}{2} ,$$

two precoding matrices are indicated by the PMI corresponding to the first sub-band: the first precoding matrix corresponds to the first

$$\frac{{N}_{PRB}^{SB}}{2} - ( {N}_{BWP , i}^{start} mod {N}_{PRB}^{SB} )$$

PRBs of the first subband and the second precoding matrix corresponds to the last

$$\frac{{N}_{PRB}^{SB}}{2}$$

PRBs of the first subband. If

$$1 + ( {N}_{BWP , i}^{start} + {N}_{BWP , i}^{size} - 1 ) mod {N}_{PRB}^{SB} \leq \frac{{N}_{PRB}^{SB}}{2} ,$$

one precoding matrix is indicated by the PMI corresponding to the last sub-band. If

$$1 + ( {N}_{BWP , i}^{start} + {N}_{BWP , i}^{size} - 1 ) mod {N}_{PRB}^{SB} > \frac{{N}_{PRB}^{SB}}{2} ,$$

two precoding matrices are indicated by the PMI corresponding to the last sub-band: the first precoding matrix corresponds to the first

$$\frac{{N}_{PRB}^{SB}}{2}$$

PRBs of the last subband and the second precoding matrix corresponds to the last

$$1 + ( {N}_{BWP , i}^{start} + {N}_{BWP , i}^{size} - 1 ) mod - \frac{{N}_{PRB}^{SB}}{2}$$

PRBs of the last subband.

TABLE 8
Codebook parameter configurations for L, β and p_{ν}

| | |
|---|---|
| paramCombination- | p_{ν} |

| r16 | L | ν ∈ {1, 2} | ν ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The UE shall report the RI value v according to the configured higher layer parameter typeII-RI-Restriction-r16. The UE shall not report u>4.

The PMI value corresponds to the codebook indices of i₁ and i₂ where

$${i}_{1} = \{ \begin{matrix}[ {i}_{1 , 1} {i}_{1 , 2} {i}_{1 , 5} {i}_{1 , 6 , 1} {i}_{1 , 7 , 1} {i}_{1 , 8 , 1} ] & v = 1 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} ] & v = 2 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} ] & v = 3 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} {i}_{1 , 6 , 4} {i}_{1 , 7 , 4} {i}_{1 , 8 , 4} ] & v = 4\end{matrix} \\ {i}_{2} = \{ \begin{matrix}[ {i}_{2 , 3 , 1} {i}_{2 , 4 , 1} {i}_{2 , 5 , 1} ] & v = 1 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} ] & v = 2 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} ] & v = 3 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} {i}_{2 , 3 , 4} {i}_{2 , 4 , 4} {i}_{2 , 5 , 4} ] & v = 4\end{matrix}$$

The precoding matrices indicated by the PMI are determined from L+Mᵥ vectors.

L vectors, vₘ_{₁}⁽ⁱ⁾, ₘ_{₂}⁽ⁱ⁾i=0,1, . . . , L-1, are identified by the indices q₁, q₂, n₁, n₂, indicated by i_{1,1}, i_{1,2}, where the values of C(x, y) are given in Table 11.

$${M}_{v} = ⌈ {p}_{v} \frac{{N}_{3}}{R} ⌉ vectors , {[ {y}_{0 , l}^{( f )} , {y}_{1 , l}^{( f )} , … , {y}_{{N}_{3} - 1 , l}^{( f )} ]}^{T} , f = 0 , 1 , … , {M}_{v} - 1$$

are identified by Mᵢₙᵢₜᵢₐₗ (for N₃>19) and n_{3,l} (l=1, . . . , v) where

$${M}_{initial} ∈ \{ - 2 {M}_{v} + 1 , - 2 {M}_{v} + 2 , … , 0 \} \\ {n}_{3 , l} = [ {n}_{3 , l}^{( 0 )} , … , {n}_{3 , l}^{( {M}_{v} - 1 )} ] \\ {n}_{3 , l}^{( f )} ∈ \{ 0 , 1 , … , {N}_{3} - 1 \}$$

which are indicated by means of the indices i_{1,5} (for N₃>19) and i_{1,6,l} (for Mᵥ>1 and l=1, . . . , v), where

$${i}_{1 , 5} ∈ \{ 0 , 1 , … , 2 {M}_{v} - 1 \} \\ {i}_{1 , 6 , 1} ∈ \{ \begin{matrix}\{ 0 , 1 , … , ( \begin{matrix}{N}_{3} - 1 \\ {M}_{v} - 1\end{matrix} ) - 1 \} & {N}_{3} \leq 19 \\ \{ 0 , 1 , … , ( \begin{matrix}2 {M}_{v} - 1 \\ {M}_{v} - 1\end{matrix} ) - 1 \} & {N}_{3} > 19\end{matrix}$$

The amplitude coefficient indicators i_{2,3,l} and i_{2,4,l} are

$${i}_{2 , 3 , l} = [ {k}_{l , 0}^{( 1 )} {k}_{l , 1}^{( 1 )} ] \\ {i}_{2 , 4 , l} = [ {k}_{l , 0}^{( 2 )} … {k}_{l , {M}_{v} - 1}^{( 2 )} ] \\ {k}_{l , f}^{( 2 )} = [ {k}_{l , 0 , f}^{( 2} … {k}_{l , 2 L - 1 , f}^{( 2 )} ] \\ {k}_{l , p}^{( 1 )} ∈ \{ 1 , … , 15 \} \\ {k}_{l , i , f}^{( 2 )} ∈ \{ 0 , … , 7 \}$$

for l=1, . . . , v.

The phase coefficient indicator l_{2,5,l} is

$${i}_{2 , 5 , l} = [ {c}_{l , 0} … {c}_{l , {M}_{v} - 1} ] \\ {c}_{l , f} = [ {c}_{l , 0 , f} … {c}_{l , 2 L - 1 , f} ] \\ {c}_{l , i , f} ∈ \{ 0 , … , 15 \}$$

for l=1, . . . , v.

Let K₀=┌β2LM₁┐. The bitmap whose nonzero bits identify which coefficients in i_{2,4,l} and i_{2,5,l} are reported, is indicated by i_{1,7,l}

$${i}_{1 , 7 , l} = [ {k}_{l , 0}^{( 3 )} … {k}_{l , {M}_{v} - 1}^{( 3 )} ] \\ {k}_{l , f}^{( 3 )} = [ {k}_{l , 0 , f}^{( 3 )} … {k}_{l , 2 L - 1 , f}^{( 3 )} ] \\ {k}_{l , i , f}^{( 3 )} ∈ \{ 0 , 1 \}$$

for l=1, . . . , v, such that Kₗ^{NZ}=Σᵢ₌₀^{2L-1}Σ_{f=0}^{M}^{ᵥ}⁻¹k_{l,i,f}⁽³⁾≤k₀ is the number of nonzero coefficients for layer l=1, . . . , v and K^{NZ}=Σ_{l =1}^{v}Kₗ^{NZ}≤2K₀ is the total number of nonzero coefficients.

The indices of i_{2,4,l}, i_{2,5,l} and i_{1,7,l} are associated to the Mᵥ codebook indices in n_{3,l}.

The mapping from k_{l,i,f}⁽²⁾ to the amplitude coefficient p_{l,p}⁽¹⁾ is given in Table 5.2.2.2.5-2 and the mapping from k_{l,i,f}⁽²⁾ to the amplitude coefficient p_{l,i,f}⁽²⁾ is given in Table 10. The amplitude coefficients are represented by

$${p}_{l}^{( 1 )} = [ {p}_{l , 0}^{( 1 )} {p}_{l , 1}^{( 1 )} ] \\ {p}_{l}^{( 2 )} = [ {p}_{l , 0}^{( 2 )} … {p}_{l , {M}_{v} - 1}^{( 2 )} ] \\ {p}_{l , f}^{( 2 )} = [ {p}_{l , 0 , f}^{( 2 )} … {p}_{l , 2 {M}_{v} - 1 , f}^{( 2 )} ]$$

for l=1, . . . , v.

Let fₗ*ϵ{0,1, . . . , Mᵥ01} be the index of i_{2,4,l} and iₗ* ϵ{0,1, . . . , 2L-1} be the index of k_{l,f,}_{ₗ}_{*}⁽²⁾ which identify the strongest coefficient of layer l, i.e., the element k_{l,i}_{ₗ}_{*,f}_{ₗ}_{*} of i_{2,4,l}, for l=1, . . . , v. The codebook indices of n_{3,l} are remapped with respect to n_{3,l}^{f}^{ₗ}^{*)} as n_{3,l}^{(f) =(n}_{3,l}^{(f)}-n_{3,l}^{(f}^{ₗ}^{*)}) mod N₃, such that n_{3,l}^{(f}^{ₗ}^{*)}=0, after remapping. The index f is remapped with respect to fₗ* as f=(f-fₗ*)mod Mᵥ, such that the index of the strongest coefficient is fₗ*=0 (l=1, . . . , v), after remapping. The indices of i_{2,4,l}, i_{2,5,l} and i_{1,7,l} indicate amplitude coefficients, phase coefficients and bitmap after remapping.

The strongest coefficient of layer l is identified by i_{1,8,l}ϵ{0,1, . . . ,2L-1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & v = 1 \\ {i}_{l}^{*} & 1 < v \leq 4\end{matrix}$$

$$for l = 1 , … , v .$$

TABLE 9
Mapping of elements of i_{2,3,l}: k_{l,p}⁽¹⁾ to p_{l,p}⁽¹⁾

| k_{l,p}⁽¹⁾ | p_{l,p}⁽¹⁾ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 14 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ( l = 1 , … , v ) .$$

The indicators

$${k}_{l , ⌊ \frac{{i}_{l}^{*}}{L} ⌋}^{( 1 )} ,$$

k_{l,i}_{ₗ}_{*,0}⁽²⁾ and C_{l,i}_{ₗ}_{*,0} are not reported for l=1, . . . , v.
The indicator

$${k}_{l , ( ⌊ \frac{{i}_{l}^{*}}{L} ⌋ + 1 ) mod 2}^{( 1 )}$$

is reported for l=1, . . . , v.
The K^{NZ}-v indicators k_{l,i,f}⁽²⁾ for which k_{l,i,f}⁽³⁾=1,i≠iₗ*, f≠0 are reported.
The K^{NZ}-v indicators c_{l,i,f} for which k_{l,i,f}⁽³⁾=1,i≠iₗ*, f≠0 are reported.
The remaining 2L·Mᵥ·v-K^{NZ} indicators k_{l,i,f}⁽²⁾ are not reported.
The remaining 2L·Mᵥ·v-K^{NZ} indicators c_{l,i,f} are not reported.

TABLE 10
Mapping of elements of i_{2,4,l}: k_{l,i,f}⁽²⁾ to p_{l,i,f}⁽²⁾

| k_{l,i,f}⁽²⁾ | p_{l,i,f}⁽²⁾ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

The elements of n₁ and n₂ are found from i_{1,2} using the algorithm below, where the values of C (x, y) are given in Table 11.

For N₃>19, Mᵢₙᵢₜᵢₐₗ is identified by i_{1,5}.

For all values of N₃, n_{3,l}⁽⁰⁾=0 for l=1, . . . , v. If Mᵥ>1, the nonzero elements of n_{3,l}, identified by n_{3,l}⁽¹⁾, . . . , n_{3,l}^{(M}^{ᵥ}⁻¹⁾, are found from i_{1,6,l}(l=1, . . . , v), for N₃≤19, and from i_{1,6,l} (l=1, . . . , v) and Mᵢₙᵢₜᵢₐₗ, for N₃>19, using C(x, y) as defined in Table 11 and the algorithm:

S₀=0

for f=1, . . . ,Mᵥ-1

Find the largest x* ϵ{Mᵥ-1-f, . . . , N₃-1-f} in Table 11 such that

```
i_{1,6,l} − s_{f-1} ≥ C(x*,M_{ν} − f)
e_{f} = C(x*,M_{ν} − f)
s_{f} = s_{f-1} + e_{f}
if N₃ ≤ 19
  n_{3,l}^{(f)} = N₃ − 1 − x*
else
  nₗ^{(f)} = 2M_{ν} − 1 − x*
  if nₗ^{(f)} ≤ Mᵢₙᵢₜᵢₐₗ + 2M_{ν} − 1
    n_{3,l}^{(f)} = nₗ^{(f)}
  else
    n_{3,l}^{(f)} = nₗ^{(f)} + (N₃ − 2M_{ν})
  end if
end if
```

TABLE 11
Combinatorial coefficients C(x, y)

| | y | | | | | | | | |
|---|---|---|---|---|---|---|---|---|---|
| x | 1 | 2 | 3 | 4 | 5 | 6 | 7 | 8 | 9 |
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

When n_{3,l} and Mᵢₙᵢₜᵢₐₗ are known, i_{1,5} and i_{1,6,l} (l=1, . . . , v) are found as follows:
If N₃≤19, i_{1,5}=0 and is not reported. If Mᵥ=1, i_{1,6,l}=0, for l=1, . . . , v, and is not reported. If Mᵥ>1, i_{1,6,l}=Σ_{f=1}^{M}^{ᵥ}⁻¹C(N₃-1-n_{3,l}^{(f)}, Mᵥ-f), where C(x, y) is given in Table 11 and where the indices f=1, . . . , Mᵥ-1 are assigned such that n_{3,l}^{(f)} increases as f increases.
If N₃>19, Mᵢₙᵢₜᵢₐₗ is indicated by i_{1,5}, which is reported and given by

$${ki}_{1 , 5} = \{ \begin{matrix}{M}_{initial} & {M}_{initial} = 0 \\ {M}_{initial} + 2 {M}_{v} & {M}_{initial} < 0\end{matrix}$$

Only the nonzero indices n_{3,l}^{(f)} ϵIntS, where IntS={(Mᵢₙᵢₜᵢₐₗ+i) mod N₃, i=0,1, . . . , 2Mᵥ-1}, are reported, where the indices f=1, . . . , Mᵥ-1 are assigned such that n_{3,l}^{(f)} increases as f increases. Let

$${n}_{l}^{( f )} = \{ \begin{matrix}{n}_{3 , l}^{( f )} & {n}_{3 , l}^{( f )} \leq {M}_{initial} + 2 {M}_{v} - 1 \\ {n}_{3 , l}^{( f )} - ( {N}_{3} - 2 {M}_{v} ) & {n}_{3 , l}^{( f )} > {M}_{initial} + {N}_{3} - 1\end{matrix} ,$$

then i_{1,6,l}=Σ_{f'1}^{M}^{ᵥ}⁻¹C(2Mᵥ-1-nₗ^{(f)},Mᵥ-f), where C(x, y) is given in Table 11.

The codebooks for 1-4 layers are given in Table 12, where m₁⁽ⁱ⁾, m₂⁽ⁱ⁾, for i=0,1, . . . , L-1, vₘ_{₁}⁽ⁱ⁾, ₘ_{₂}⁽ⁱ⁾ are obtained, and the quantities φ_{l,i,f} and y_{t,l} are given by

$${φ}_{l , i , f} = {e}^{j \frac{2 π {c}_{l , i , f}}{16}} \\ {y}_{t , l} = [ {y}_{t , l}^{( 0 )} {y}_{t , l}^{( 1 )} … {y}_{t , l}^{( {M}_{v} - 1 )} ]$$

where t={0,1, . . . , N₃-1}, is the index associated with the precoding matrix, l={1, . . . , v}, and with

$${y}_{t , l}^{( f )} = {e}^{j \frac{2 π {tn}_{3 , l}^{( f )}}{{N}_{3}}}$$

for f=0,1, . . . , Mᵥ-1.

TABLE 12
Codebook for 1-layer. 2-layer, 3-layer and 4-layer CSI reporting using antenna ports 3000 to 2999 + PCSI-RS

| Layers | |
|---|---|
| υ = 1 | W_{q}_{₁}_{,q}_{₂}_{,n}_{₁}_{,n}_{₂}_{,n}_{_{3,1}}_{,p}_{₁}_{⁽¹⁾}_{,p}_{₁}_{⁽²⁾}_{,i}_{_{2,5,1}}_{,t}⁽¹⁾ = W_{q}_{₁}_{,q}_{₂}_{,n}_{₁}_{,n}_{₂}_{,n}_{_{3,1}}_{,p}_{₁}_{⁽¹⁾}_{,p}_{₁}_{⁽²⁾}_{,i}_{_{2,5,1}}_{,t}¹ |
| υ = 2 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} ]$ |
| υ = 3 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \frac{1}{\sqrt{3}} [ {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} {W}_{{q}_{1} , {q}_{2} , {n}_{1} , {n}_{2} , {n}_{3 , 3} , {p}_{3}^{( 1 )} , {p}_{3}^{( 2 )} ,}^{3} \text{} \text{?}$ |
| υ = 4 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \frac{1}{2} [ {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} {W}_{{q}_{1} , {q}_{2} , {n}_{1} , {n}_{2} , {n}_{3 , 3} , {p}_{3}^{( 1 )} , {p}_{3}^{( 2 )} ,}^{3} \text{} \text{?}$ |

Where
${W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} , t}^{l} = \frac{1}{\sqrt{{N}_{1} {N}_{2} {γ}_{t , l}}} [ \begin{matrix}{Σ}_{i = 0}^{L - 1} {v}_{{m}_{1}^{( i )} , {m}_{2}^{( i )}} {p}_{l , 0}^{( 1 )} {Σ}_{f = 0}^{{M}_{υ} - 1} {y}_{t , l}^{( f )} {p}_{l , i , f}^{( 2 )} {φ}_{l , i , f} \\ {Σ}_{i = 0}^{L - 1} {v}_{{m}_{1}^{( i )} , {m}_{2}^{( i )}} {p}_{l , 1}^{( 1 )} {Σ}_{f = 0}^{{M}_{υ} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} \vert}^{2}$
and the mappings from i₁ to q₁, q₂, n₁, n₂, n_{3,1}, n_{3,2}, n_{3,3}, n_{3,4}, and from i₂ to i_{2,5,1}, i_{2,5,2}, i_{2,5,3}, i_{2,5,4}, p₁⁽¹⁾, p₂⁽¹⁾, p₃⁽¹⁾ and
p₄⁽¹⁾, p₁⁽²⁾, p₂⁽²⁾, p₃⁽²⁾ and p₄⁽²⁾ are as described above, including the ranges of the constituent indices of i₁ and i₂.
$\text{?} \text{indicates text missing or illegible when filed}$

For coefficients with k_{l,i,f}⁽³⁾=0, amplitude and phase are set to zero, i.e., p_{l,i,f}⁽²⁾=0 and φ_{l,i,f}=0.

The bitmap parameter typeII-RI-Restriction-r16 forms the bit sequence r₃, r₂, r₁, r₀ where r₀ is the LSB and r₃ is the MSB. When rᵢ is zero, i ϵ{0,1, . . . , 3}, PMI and RI reporting are not allowed to correspond to any precoder associated with v=i+1 layers.

The bitmap parameter n1-n2-codebookSubsetRestriction-r16 forms the bit sequence B=B₁B₂ and configures the vector group indices g^{(k)} as in clause 5.2.2.2.3. Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed average amplitude, γ_{i+pL} (p=0,1), with i ϵ{0,1, . . . , L-1}, of the coefficients associated with the vector in group g^{(k)} indexed by x₁, x₂, where the maximum amplitudes are given in Table 13 and the average coefficient amplitude is restricted as follows

$$\sqrt{\frac{1}{{\sum }_{f = 0}^{{M}_{v} - 1} {k}_{l , i + pL , f}^{( 3 )}} {\sum }_{f = 0}^{{M}_{v} - 1} {{k}_{l , i + pL , f}^{( 3 )} ( {p}_{l , p}^{( 1 )} {p}_{l , i + pL , f}^{( 2 )} )}^{2}} \leq {γ}_{i + pL}$$

for l=1, . . . , v, and p=0,1. A UE that does not report the parameter amplitudeSubsetRestriction=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

TABLE 13
Maximum allowed average coefficient amplitudes for restricted vectors

| Bit | Maximum Average Coefficient |
|---|---|
| b₂^{k,2(N}^{₁}^{x}^{₂}^{+x}^{₁}⁾⁺¹⁾b₂^{(k,2(N}^{₁}^{x}^{₂}^{+x}^{₁}⁾⁾ | Amplitude γ_{i+pL} |
| 00 | 0 |
| 01 | $\sqrt{1 / 4}$ |
| 10 | $\sqrt{1 / 2}$ |
| 11 | 1 |

Regarding 3GPP NR Rel-16, for Type-II Port Selection codebook, only K (where K≤2N1N2) beamformed CSI-RS ports are utilized in DL transmission, in order to reduce complexity. The K×N3 codebook matrix per layer takes on the form:

$$W = {W}_{1}^{PS} {\tilde{W}}_{2} {W}_{f}^{H}$$

Here, \tilde{W}₂ and W₃ follow the same structure as the conventional NR Rel-16 Type-II Codebook, where both are layer specific. The matrix W₁^{PS} is a K×2Z block-diagonal matrix with the same structure as that in the NR Rel-15 Type-II Port Selection Codebook.

In more detail, the specification for the NR Rel. 16 Type-II Port Selection Codebook is as follows (see 3GPP NR TS 38.214):

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection-r16’
The number of CSI-RS ports is configured as in Clause 5.2.2.2.4 of TS 38.214
The value of d is configured with the higher layer parameter portSelectionSamplingSize-r16, where d ϵ{1,2,3,4} and d≤L.
The values L, β and pᵥ are configured as in Clause 5.2.2.2.5 of TS 38.214, where the supported configurations are given in Table 14.

TABLE 14
Codebook parameter configurations for L, β andp_{ν}

| | |
|---|---|
| paramCombination- | p_{ν} |

| r16 | L | ν ∈ {1, 2} | ν ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

The UE shall report the RI value v according to the configured higher layer parameter typeII-PortSelectionRI-Restriction-r16. The UE shall not report v>4.
The values of R is configured as in Clause 5.2.2.2.5 of TS 38.214.

The UE is also configured with the higher layer bitmap parameter typeII-PortSelectionRI-Restriction-r16, which forms the bit sequence r₃, r₂, r₁, r₀, where r₀ is the LSB and r₃ is the MSB. When rᵢ is zero, i ϵ{0,1, . . . , 3}, PMI and RI reporting are not allowed to correspond to any precoder associated with v=i+1 layers.

The PMI value corresponds to the codebook indices i₁ and i₂ where

$${i}_{1} = \{ \begin{matrix}[ {i}_{1 , 1} {i}_{1 , 5} {i}_{1 , 6 , 1} {i}_{1 , 7 , 1} {i}_{1 , 8 , 1} ] & v = 1 \\ [ {i}_{1 , 1} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} ] & v = 2 \\ [ {i}_{1 , 1} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} ] & v = 3 \\ [ {i}_{1 , 1} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} {i}_{1 , 6 , 4} {i}_{1 , 7 , 4} {i}_{1 , 8 , 4} ] & v = 4\end{matrix} \\ {i}_{2} = \{ \begin{matrix}[ {i}_{2 , 3 , 1} {i}_{2 , 4 , 1} {i}_{2 , 5 , 1} ] & v = 1 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} ] & v = 2 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} ] & v = 3 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} {i}_{2 , 3 , 4} {i}_{2 , 4 , 4} {i}_{2 , 5 , 4} ] & v = 4\end{matrix}$$

The 2L antenna ports are selected by the index (1,1 as in clause 5.2.2.2.4 of TS 38.214.

Parameters N₃, Mᵥ, Mᵢₙᵢₜᵢₐₗ (for N₃>19) and K₀ are defined as in clause 5.2.2.2.5 of TS 38.214.

For layer l, l=1, . . . , v, the strongest coefficient i_{1,8,l}, the amplitude coefficient indicators i_{2,3,l} and i_{2,4,l}, the phase coefficient indicator i_{2,5,l} and the bitmap indicator i_{1,7,l} are defined and indicated as in clause 5.2.2.2.5, where the mapping from k_{i,p}⁽¹⁾ to the amplitude coefficient p_{l,p}⁽¹⁾ is given in Table 9 and the mapping from k_{l,i,f}⁽²⁾ to the amplitude coefficient p_{l,i,f}⁽²⁾ is given in Table 10.

The number of nonzero coefficients for layer l, Kₗ^{NZ}, and the total number of nonzero coefficients K^{NZ} are defined as in Clause 5.2.2.2.5 of TS 38.214.

The amplitude coefficients pₗ⁽¹⁾ and pₗ⁽²⁾ (l=1, . . . , v) are represented as in clause 5.2.2.2.5.

The amplitude and phase coefficient indicators are reported as in clause 5.2.2.2.5 of TS 38.214.

Codebook indicators i_{1,5} and i_{1,6,l} (l=1, . . . , v) are found as in clause 5.2.2.2.5 of TS 38.214.

The codebooks for 1-4 layers are given in Table 15, where vₘ is a P_{CSI-RS}/2-element column vector containing a value of 1 in element (m mod P_{CSI-RS}/2) and zeros elsewhere (where the first element is element 0), and the quantities φ_{l,i,f} and y_{t,l} are defined as in clause 5.2.2.2.5 of TS 38.214.

TABLE 15
Codebook for 1-layer. 2-layer, 3-layer and 4-layer CSI reporting using antenna ports 3000 to 2999 + PCSI-RS

| Layers | |
|---|---|
| υ = 1 | Wᵢ_{_{1,1}}_{,n}_{_{3,1}}_{,p}_{₁}_{⁽¹⁾}_{,p}_{₁}_{⁽²⁾}_{,i}_{_{2,5,1}}_{,t}⁽¹⁾ = Wᵢ_{_{1,1}}_{,n}_{_{3,1}}_{,p}_{₁}_{⁽¹⁾}_{,p}_{₁}_{⁽²⁾}_{,i}_{_{2,5,1}}_{,t}¹ |
| υ = 2 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ {W}_{{i}_{1 , 1} , {n}_{3 , 1} , {p}_{1}^{( 1 )} , {p}_{1}^{( 2 )} , {i}_{2 , 5 , 1} , t}^{1} {W}_{{i}_{1 , 1} , {n}_{3 , 2} , {p}_{2}^{( 1 )} , {p}_{2}^{( 2 )} , {i}_{2 , 5 , 2} , t}^{2} ]$ |
| υ = 3 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \frac{1}{\sqrt{3}} [ {W}_{{i}_{1 , 1} , {n}_{3 , 1} , {p}_{1}^{( 1 )} , {p}_{1}^{( 2 )} , {i}_{2 , 5 , 1} , t}^{1} {W}_{{i}_{1 , 1} , {n}_{3 , 2} , {p}_{2}^{( 1 )} , {p}_{2}^{( 2 )} , {i}_{2 , 5 , 2} , t}^{2} {W}_{{i}_{1 , 1} , {n}_{3 , 3} , {p}_{3}^{( 1 )} , {p}_{3}^{( 2 )} , {i}_{2 , 5 , 3} , t}^{3} ]$ |
| υ = 4 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \frac{1}{2} [ {W}_{{i}_{1 , 1} , {n}_{3 , 1} , {p}_{1}^{( 1 )} , {p}_{1}^{( 2 )} , {i}_{2 , 5 , 1} , t}^{1} {W}_{{i}_{1 , 1} , {n}_{3 , 2} , {p}_{2}^{( 1 )} , {p}_{2}^{( 2 )} , {i}_{2 , 5 , 2} , t}^{2} {W}_{{i}_{1 , 1} , {n}_{3 , 3} , {p}_{3}^{( 1 )} , {p}_{3}^{( 2 )} , {i}_{2 , 5 , 3} , t}^{3} {W}_{{i}_{1 , 1} , {n}_{3 , 4} , {p}_{4}^{( 1 )} , {p}_{4}^{( 2 )} , \text{?}}^{4}$ |

${W}_{{i}_{1 , 1} , {n}_{3} , {p}_{l}^{( 1 )} , {p}_{l}^{( 2 )} , {i}_{2 , 5 , l} , t}^{l} = \frac{1}{\sqrt{{γ}_{t , l}}} [ \begin{matrix}{Σ}_{i = 0}^{L - 1} {v}_{{i}_{1 , 1} , d + i} {p}_{l , 0}^{( 1 )} {Σ}_{f = 0}^{{M}_{υ} - 1} {y}_{t , l}^{( f )} {p}_{l , i , f}^{( 2 )} {φ}_{l , i , f} \\ {Σ}_{i = 0}^{L - 1} {v}_{{i}_{1 , 1} , d + i} {p}_{l , 1}^{( 1 )} {Σ}_{f = 0}^{{M}_{υ} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} \vert}^{2}$
and the mappings from i₁ to i_{1,1}, n_{3,1}, n_{3,2}, n_{3,3}, n_{3,4}, and from i₂ to i_{2,5,1}, i_{2,5,2}, i_{2,5,3}, i_{2,5,4}, p₁⁽¹⁾, p₂⁽¹⁾ , p₃⁽¹⁾ and
p₄⁽¹⁾, p₁⁽²⁾, p₂⁽²⁾, p₃⁽²⁾ and p₄⁽²⁾ are as described above, including the ranges of the constituent indices of i₁ and i₂.
$\text{?} \text{indicates text missing or illegible when filed}$

For coefficients with k_{l,i,f}⁽³⁾=0, amplitude and phase are set to zero, i.e., p_{l,i,f}⁽²⁾=0 and φ_{l,i,f}=0.

Regarding UE SRS configuration, as discussed in 3GPP TS 38.214, the UE may be configured with one or more SRS resource sets as configured by the higher-layer parameter SRS-ResourceSet, wherein each SRS resource set is associated with K≥1 SRS resources (higher-layer parameter SRS-Resource), where the maximum value of K is indicated by UE capability. The SRS resource set applicability is configured by the higher-layer parameter usage in SRS-ResourceSet. The higher-layer parameter SRS-Resource configures some SRS parameters, including the SRS resource configuration identity (srs-Resourceld), the number of SRS ports (nrofSRS-Ports) with default value of one, and the time-domain behavior of SRS resource configuration (resource Type).

The UE may be configured by the higher-layer parameter resourceMapping in SRS-Resource with an SRS resource occupying Nsϵ{1,2,4} adjacent symbols within the last 6 symbols of the slot, where all antenna ports of the SRS resources are mapped to each symbol of the resource.

For a UE configured with one or more SRS resource configuration(s), and when the higher-layer parameter resourceType in SRS-Resource is set to ‘aperiodic’:
The UE receives a configuration of SRS resource sets,
The UE receives a downlink downlink control information (“DCI”), a group common DCI, or an uplink DCI based command where a codepoint of the DCI may trigger one or more SRS resource set(s). For SRS in a resource set with usage set to ‘codebook’ or ‘antennaSwitching’, the minimal time interval between the last symbol of the physical downlink control channel (“PDCCH”) triggering the aperiodic SRS transmission and the first symbol of SRS resource is N2. Otherwise, the minimal time interval between the last symbol of the PDCCH triggering the aperiodic SRS transmission and the first symbol of SRS resource is N2+14. The minimal time interval in units of orthogonal frequency division multiplexing (“OFDM”) symbols is counted based on the minimum subcarrier spacing between the PDCCH and the aperiodic SRS.
If the UE is configured with the higher-layer parameter spatial RelationInfo containing the ID of a reference ‘ssb-Index’, the UE shall transmit the target SRS resource with the same spatial domain transmission filter used for the reception of the reference synchronization signal (“SS”)/physical broadcast channel (“PBCH”) block, if the higher-layer parameter spatialRelationInfo contains the ID of a reference ‘csi-RS-Index’, the UE shall transmit the target SRS resource with the same spatial domain transmission filter used for the reception of the reference periodic CSI-RS or of the reference semi-persistent CSI-RS, or of the latest reference aperiodic CSI-RS. If the higher-layer parameter spatialRelationInfo contains the ID of a reference ‘srs’, the UE shall transmit the target SRS resource with the same spatial domain transmission filter used for the transmission of the reference periodic SRS or of the reference semi-persistent SRS or of the reference aperiodic SRS.
The update command contains spatial relation assumptions provided by a list of references to reference signal IDs, one per element of the updated SRS resource set. Each ID in the list refers to a reference SS/PBCH block, non-zero power (“NZP”) CSI-RS resource configured on serving cell indicated by Resource Serving Cell ID field in the update command if present, same serving cell as the SRS resource set otherwise, or SRS resource configured on serving cell and uplink bandwidth part indicated by Resource Serving Cell ID field and Resource BWP ID field in the update command if present, same serving cell and bandwidth part as the SRS resource set otherwise.
When the UE is configured with the higher-layer parameter usage in SRS-Resource Set set to ‘antennaSwitching’, the UE shall not expect to be configured with different spatial relations for SRS resources in the same SRS resource set.

For physical uplink control channel (“PUCCH”) and SRS on the same carrier, a UE shall not transmit SRS when semi-persistent and periodic SRS are configured in the same symbol(s) with PUCCH carrying only CSI report(s), or only L1-RSRP report(s), or only L1-SINR report(s). A UE shall not transmit SRS when semi-persistent or periodic SRS is configured or aperiodic SRS is triggered to be transmitted in the same symbol(s) with PUCCH carrying HARQ-ACK, link recovery request and/or SR. In the case that SRS is not transmitted due to overlap with PUCCH, only the SRS symbol(s) that overlap with PUCCH symbol(s) are dropped. PUCCH shall not be transmitted when aperiodic SRS is triggered to be transmitted to overlap in the same symbol with PUCCH carrying semi-persistent/periodic CSI report(s) or semi-persistent/periodic L1-RSRP report(s) only, or only L1-SINR report(s).

When the UE is configured with the higher-layer parameter usage in SRS-ResourceSet set to ‘antennaSwitching’, and a guard period of Y symbols is configured, the UE shall use the same priority rules as defined above during the guard period as if SRS was configured.

Regarding UE sounding procedure for DL CSI acquisition, when the UE is configured with the higher-layer parameter usage in SRS-ResourceSet set as ‘antennaSwitching’, the UE may be configured with one configuration depending on the indicated UE capability supportedSRS-TxPortSwitch, which takes on the values {‘t1r2’, ‘t1r1-tlr2’, ‘t2r4’, ‘t1r4’, ‘t1r1-t1r2-t1r4’, ‘t1r4-t2r4’, ‘t1r1-t1r2-t2r2-t2r4’, ‘t1r1-t1r2-t2r2-t1r4-t2r4’, ‘t1r1’, ‘t2r2’, ‘t1r1-t2r2’, ‘t4r4’, ‘t1r1-t2r2-t4r4’}
For 1T2R, up to two SRS resource sets configured with a different value for the higher-layer parameter resourceType in SRS-ResourceSet set, where each set has two SRS resources transmitted in different symbols, each SRS resource in a given set consisting of a single SRS port, and the SRS port of the second resource in the set is associated with a different UE antenna port than the SRS port of the first resource in the same set, or
For 2T4R, up to two SRS resource sets configured with a different value for the higher-layer parameter resourceType in SRS-ResourceSet set, where each SRS resource set has two SRS resources transmitted in different symbols, each SRS resource in a given set consisting of two SRS ports, and the SRS port pair of the second resource is associated with a different UE antenna port pair than the SRS port pair of the first resource, or
For 1T4R, zero or one SRS resource set configured with higher-layer parameter resource Type in SRS-ResourceSet set to ‘periodic’ or ‘semi-persistent’ with four SRS resources transmitted in different symbols, each SRS resource in a given set consisting of a single SRS port, and the SRS port of each resource is associated with a different UE antenna port, and
For 1T4R, zero or two SRS resource sets each configured with higher-layer parameter resourceType in SRS-ResourceSet set to ‘aperiodic’ and with a total of four SRS resources transmitted in different symbols of two different slots, and where the SRS port of each SRS resource in the given two sets is associated with a different UE antenna port. The two sets are each configured with two SRS resources, or one set is configured with one SRS resource and the other set is configured with three SRS resources.
For 1T=1R, or 2T=2R, or 4T=4R, up to two SRS resource sets each with one SRS resource, where the number of SRS ports for each resource is equal to 1, 2, or 4.

The UE is configured with a guard period of Y symbols, in which the UE does not transmit any other signal, in the case the SRS resources of a set are transmitted in the same slot. The guard period is in-between the SRS resources of the set. The value of Y is 2 when the OFDM sub-carrier spacing is 120 kHz, otherwise Y=1.

For 1T2R, 1T4R or 2T4R, the UE shall not expect to be configured or triggered with more than one SRS resource set with higher-layer parameter usage set as ‘antennaSwitching’ in the same slot. For 1T=IR, 2T=2R or 4T=4R, the UE shall not expect to be configured or triggered with more than one SRS resource set with higher-layer parameter usage set as ‘antennaSwitching’ in the same symbol.

Regarding CSI reporting, the codebook report is partitioned into two parts based on the priority of information reported. Each part is encoded separately (Part 1 has a possibly higher code rate). Below we list the parameters for NR Rel. 16 Type-II codebook only. More details can be found in TS38.214 Sec5.2.3-4.

Note that multiple CSI reports may be transmitted, where the CSI reports would be reported via the priority reporting levels of CSI Part 2 in the table below:

TABLE
Priority reporting levels for Part 2 CSI

Priority 0:
For CSI reports 1 to N_{Rep}, Group 0 CSI for CSI reports
configured as ‘typeII-r16’ or ‘typeII-PortSelection-r16’;
Part 2 wideband CSI for CSI reports configured otherwise
Priority 1:
Group 1 CSI for CSI report 1, if configured as ‘typeII-r16’ or
‘typeII-PortSelection-r16’; Part 2 subband CSI of even subbands
for CSI report 1, if configured otherwise
Priority 2:
Group 2 CSI for CSI report 1, if configured as ‘typeII-r16’ or
‘typeII-PortSelection-r16’; Part 2 subband CSI of odd subbands
for CSI report 1, if configured otherwise
Priority 3:
Group 1 CSI for CSI report 2, if configured as ‘typeII-r16’
or ‘typeII-PortSelection-r16’; Part 2 subband CSI of even subbands
for CSI report 2, if configured otherwise
Priority 4:
Group 2 CSI for CSI report 2, if configured as ‘typeII-r16’
or ‘typeII-PortSelection-r16’. Part 2 subband CSI of odd subbands
for CSI report 2, if configured otherwise
.
.
.
Priority 2N_{Rep} − 1:
Group 1 CSI for CSI report N_{Rep}, if configured as ‘typeII-r16’
or ‘typeII-PortSelection-r16’; Part 2 subband CSI of even subbands
for CSI report N_{Rep}, if configured otherwise
Priority 2_{NRep}:
Group 2 CSI for CSI report N_{Rep}, if configured as ‘typeII-r16’
or ‘typeII-PortSelection-r16’; Part 2 subband CSI of odd subbands
for CSI report N_{Rep}, if configured otherwise

Note that the priority of the N_{Rep} CSI reports are based on the following
a. A CSI report corresponding to one CSI reporting configuration for one cell may have higher priority compared with another CSI report corresponding to one other CSI reporting configuration for the same cell
b. CSI reports intended to one cell may have higher priority compared with other CSI reports intended to another cell
c. CSI reports may have higher priority based on the CSI report content, e.g., CSI reports carrying L1-RSRP information have higher priority
d. CSI reports may have higher priority based on their type, e.g., whether the CSI report is aperiodic, semi-persistent or periodic, and whether the report is sent via PUSCH or PUCCH, may impact the priority of the CSI report

In light of that, CSI reports may be prioritized as follows, where CSI reports with lower IDs have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations

c: Cell index, and N_{cells}: Number of serving cells

k: 0 for CSI reports carrying L1-RSRP or L1-SINR, 1 otherwise

y: 0 for aperiodic reports, 1 for semi-persistent reports on PUSCH, 2 for semi-persistent reports on PUCCH, 3 for periodic reports.

Regarding triggering priority for CSI reporting, the UE needs to report the needed CSI information for the network using the CSI framework in NR Release 15. From a UE perspective, CSI reporting is independent of what NCJT scheme is used on the downlink. The triggering mechanism between a report setting and a resource setting can be summarized in below.

TABLE
Triggering mechanism between a report
setting and a resource setting

| | | Periodic CSI | SP CSI | AP CSI |
|---|---|---|---|---|
| | | reporting | reporting | Reporting |
| Time Domain | Periodic | RRC | MAC CE (PUCCH) | DCI |
| Behaviour | CSI-RS | configured | DCI (PUSCH) | |
| of Resource | SP | Not | MAC CE (PUCCH) | DCI |
| Setting | CSI-RS | Supported | DCI (PUSCH) | |
| | AP | Not | Not Supported | DCI |
| | CSI-RS | Supported | | |

Moreover,
a. All associated Resource Settings for a CSI Report Setting need to have same time domain behavior.
b. Periodic CSI-RS/IM resource and CSI reports are always assumed to be present and active once configured by RRC
c. Aperiodic and semi-persistent CSI-RS/IM resources and CSI reports needs to be explicitly triggered or activated.
d. Aperiodic CSI-RS/IM resources and aperiodic CSI reports, the triggering is done jointly by transmitting a DCI Format 0-1.
c. Semi-persistent CSI-RS/IM resources and semi-persistent CSI reports are independently activated.

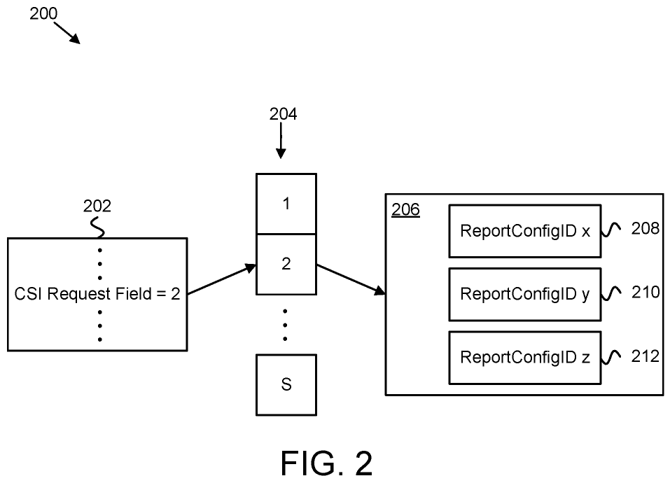

For multi-TRP NCJT, aperiodic CSI reporting is likely to be triggered to inform the network about the channel conditions for every transmission hypothesis, since using periodic CSI-RS for the TRPs in the coordination cluster constitutes a large overhead. As mentioned earlier, for aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC (see FIG. 2).

FIG. 2 depicts a diagram 200 illustrating one embodiment of an aperiodic trigger state defining a list of CSI report settings. Specifically, the diagram 200 includes a DCI format 0_1 202, a CSI request codepoint 204, and an aperiodic trigger state 2 206. Moreover, the aperiodic trigger state 2 includes a ReportConfigID x 208, a ReportConfigID y 210, and a ReportConfigID z 212. For aperiodic CSI-RS/IM resources and aperiodic CSI reports, the triggering is done jointly by transmitting a DCI Format 0-1. The DCI Format 0-1 contains a CSI request field (0 to 6 bits). A non-zero request field points to a so-called aperiodic trigger state configured by RRC. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

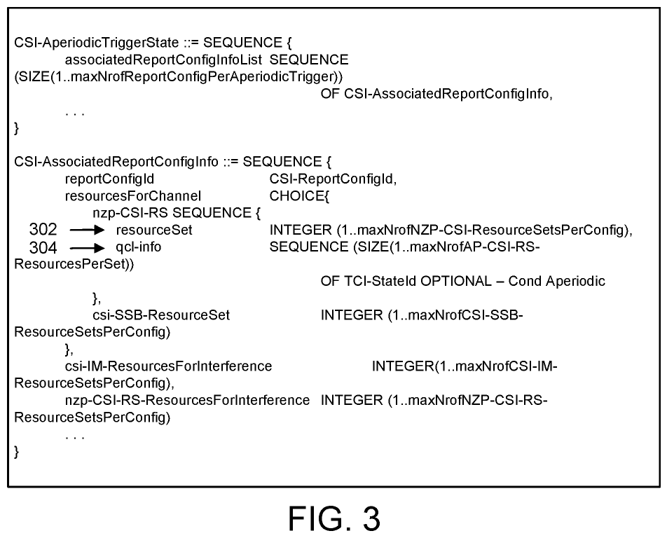

FIG. 3 depicts aperiodic trigger state that indicates the resource set 302 and QCL information 304. When the CSI Report Setting is linked with aperiodic Resource Setting (can comprise multiple Resource Sets), the aperiodic NZP-CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP-CSI-RS, the QCL source to use is also configured in the aperiodic trigger state. The UE assumes that the resources used for the computation of the channel and interference can be processed with the same spatial filter i.e., quasi-co-located with respect to “QCL-TypeD.”

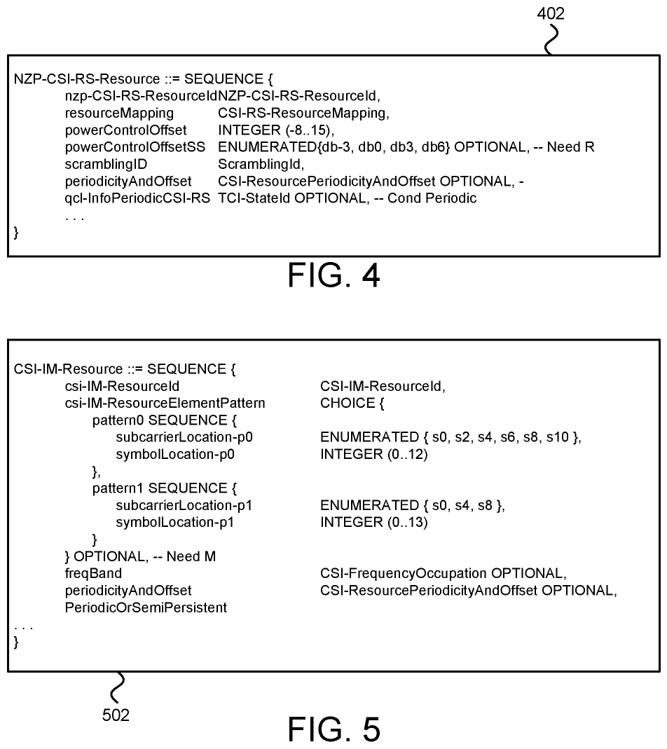

FIG. 4 is a code sample 402 illustrating one embodiment of the process by which an aperiodic trigger state indicates a resource set and QCL information.

FIG. 5 is a code sample 502 illustrating one embodiment of an RRC configuration including a NZP-CSI-RS resource and a CSI-IM-resource.

The table below summarizes the type of uplink channels used for CSI reporting as a function of the CSI codebook type.

TABLE
uplink channels used for CSI reporting
as a function of the CSI codebook type

| | Periodic CSI | SP CSI | AP CSI |
|---|---|---|---|
| | reporting | reporting | reporting |
| Type I WB | PUCCH Format 2, 3, 4 | PUCCH Format 2 | PUSCH |
| | | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II | | PUCCH Format 3, 4 | |
| Part 1 only | | | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following:
a. RI (if reported), CRI (if reported) and CQI for the first codeword,
b. number of non-zero wideband amplitude coefficients per layer for Type II CSI feedback on PUSCH.

CSI Part 2 has a variable payload size that can be derived from the CSI parameters in CSI Part 1, and contains PMI and the CQI for the second codeword when RI>4.

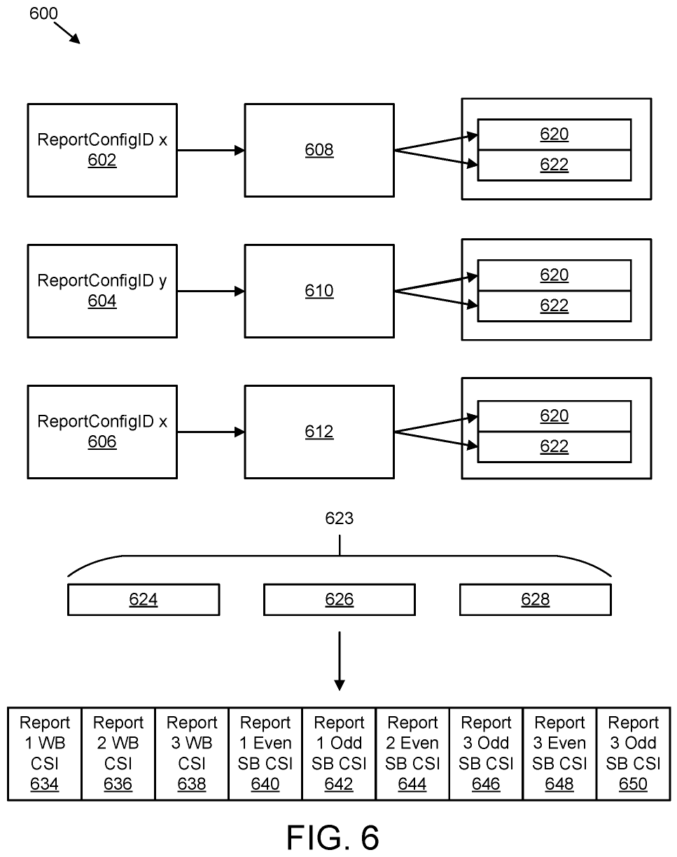

For example, if the aperiodic trigger state indicated by DCI format 0_1 defines 3 report settings x, y, and z, then the aperiodic CSI reporting for CSI part 2 will be ordered as indicated in FIG. 6.

FIG. 6 is a schematic block diagram 600 illustrating one embodiment of a partial CSI omission for PUSCH-based CSI. The diagram 600 includes a ReportConfigID x 602, a ReportConfigID y 604, and a ReportConfigID z 606. Moreover, the diagram 600 includes a first report 608 (e.g., requested quantities to be reported) corresponding to the ReportConfigID x 602, a second report 610 (e.g., requested quantities to be reported) corresponding to the ReportConfigID y 604, and a third report 612 (e.g., requested quantities to be reported) corresponding to the ReportConfigID z 606. Each of the first report 608, the second report 610, and the third report 612 includes a CSI part 1 620, and a CSI part 2 622. An ordering 623 of CSI part 2 across reports is CSI part 2 of the first report 624, CSI part 2 of the second report 626, and CSI part 2 of the third report 628. Moreover, the CSI part 2 reports may produce a report 1 WB CSI 634, a report 2 WB CSI 636, a report 3 WB CSI 638, a report 1 even SB CSI 640, a report 1 odd SB CSI 642, a report 2 even SB CSI 644, a report 2 odd SB CSI 646, a report 3 even SB CSI 648, and a report 3 odd SB CSI 650.

As mentioned earlier, CSI reports are prioritized according to:
a. Time-domain behavior and physical channel, where more dynamic reports are given precedence over less dynamic reports and PUSCH has precedence over PUCCH.
b. CSI content, where beam reports (i.e. L1-RSRP reporting) has priority over regular CSI reports.
c. Serving cell to which the CSI corresponds (in case of CA operation). CSI corresponding to the PCell has priority over CSI corresponding to Scells.
d. The ID of the CSI Report Configuration reportConfigID.

In general, a UE is configured by higher-layers with one or more CSI-ReportConfig Reporting Settings, wherein each Reporting Setting may configure at least one CodebookConfig Codebook Configuration or one reportQuantity Reporting Quantity, or both, for CSI Reporting. Each Codebook Configuration represents at least one codebookType Codebook type, which includes indicators representing at least one or more of a CSI-RS Resource Indicator (“CRI”), a Synchronization-Signal Block Resource Indicator (“SSBRI”), a Rank Indicator (“RI”), a Precoding Matrix Indicator (“PMI”), a Channel Quality Indicator (“CQI”), a Layer Indicator (“LI”), a Layer-1 Reference Signal Received Power “(LI-RSRP”) and a Layer-1 Signal-to-Interference-plus-Noise Ratio (“LI-SINR”). Several embodiments are described below. According to a possible embodiment, one or more elements or features from one or more of the described embodiments may be combined.

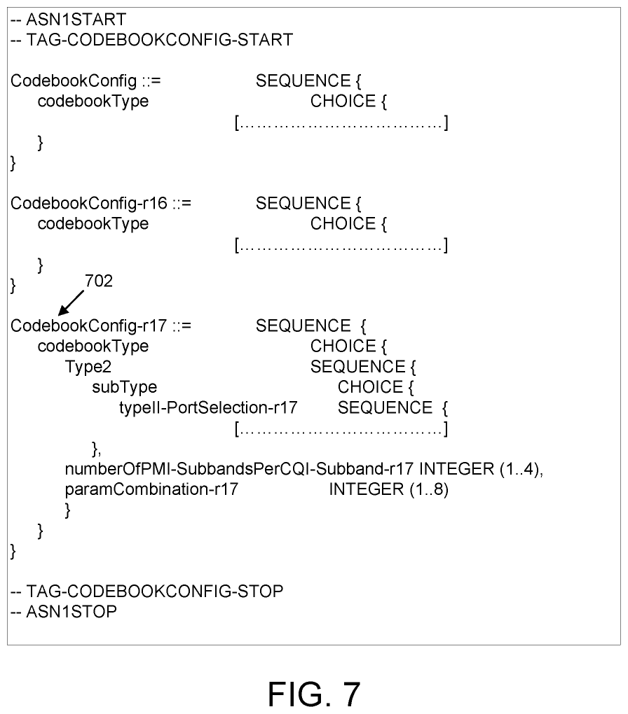

Regarding indication of reciprocity-based codebook, the network may configure a UE with a reciprocity-based codebook as part of CSI feedback reporting, via one or more of the indications discussed below with reference to FIGS. 7-9.

FIG. 7 depicts an example of Abstract Syntax Notation One (“ASN.1”) code for configuring the UE with a reciprocity-based codebook, according to a first alternative. According to the first alternative, the network introduces one or more additional values to the higher-layer parameter CodebookType. In one embodiment, the parameter CodebookType may be part of one or more Codebook Configuration Information Elements (“IE”) that were introduced in Rel-15 and Rel-16, i.e., CodebookConfig, or CodebookConfig-r16, respectively. In another embodiment, a new Codebook Configuration is introduced in Rel. 17, i.e., CodebookConfig-r17 702. All the Codebook Configuration IEs are part of the CSI-ReportConfig Reporting Setting IE. Examples of the additional values of the CodebookType parameter are ‘typeII-PortSelection-r17’, or ‘typeIl-Reciprocity’. An example of the ASN.1 code that corresponds to the latter embodiment is provided in FIG. 2 for the Codebook Configuration IE.

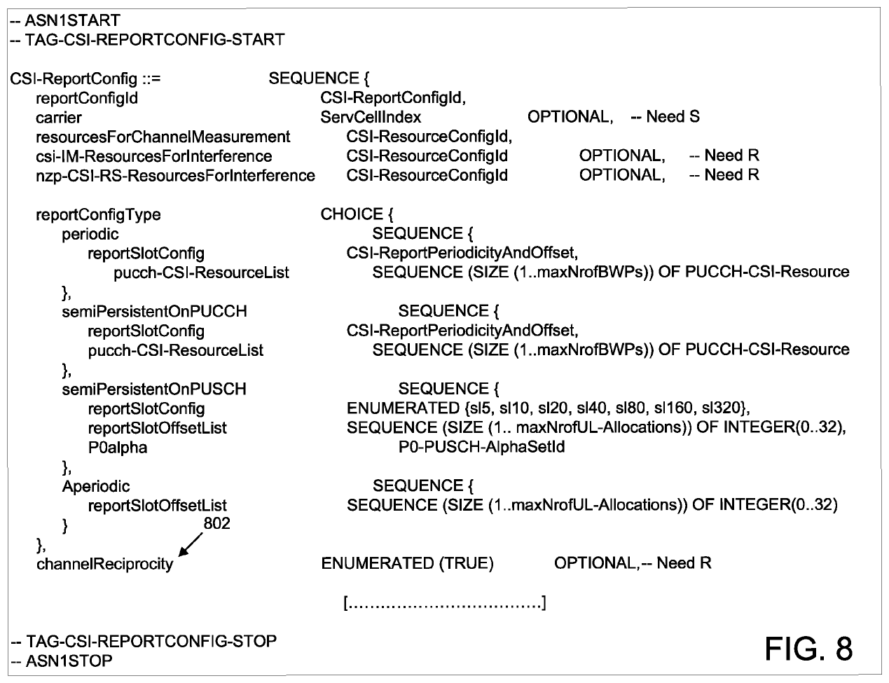

FIG. 8 depicts an example of ASN.1 code for configuring the UE with a reciprocity-based codebook, according to a second alternative. According to the second alternative, the network introduces an additional higher-layer parameter, e.g., channelReciprocity 802, within the CSI-ReportConfig Reporting Setting IE that configures the UE with CSI feedback reporting based on channel reciprocity. The Channel Reciprocity parameter may appear in different sub-elements of the Reporting Setting IE. An Example of the ASN.1 code that corresponds to this embodiment is provided in FIG. 3 for the CSI-ReportConfig Reporting Setting IE.

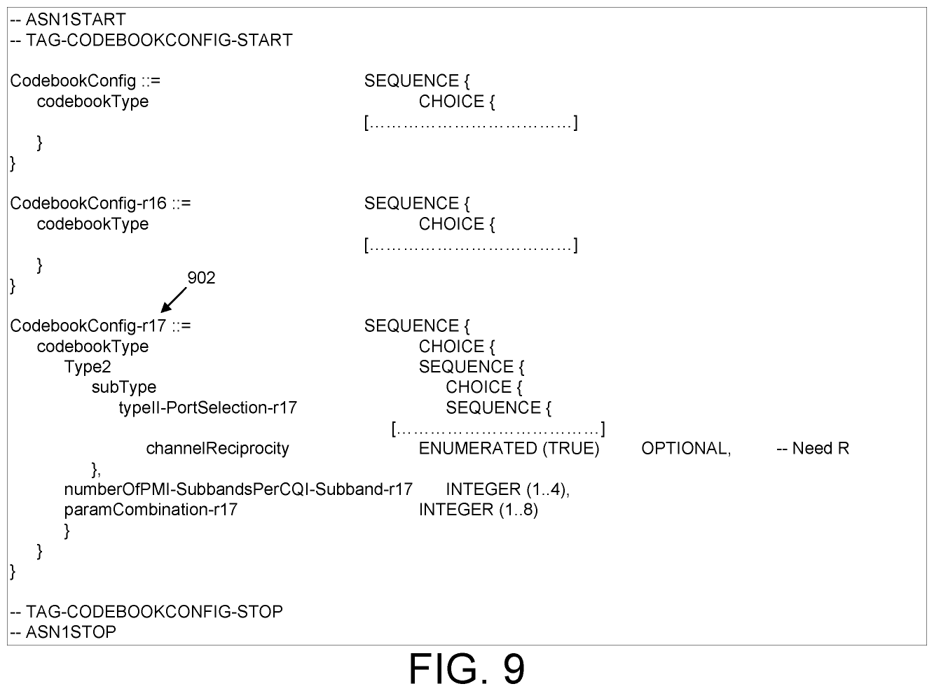

FIG. 9 depicts an example of ASN.1 code for configuring the UE with a reciprocity-based codebook, according to a third alternative. According to the third alternative, the network introduces an additional higher-layer parameter, e.g., channelReciprocity, within the Codebook Configuration CodebookConfig IE. In one embodiment, the new parameter is under the Codebook Configuration IE, e.g., CodebookConfig, CodebookConfig-r16. In another embodiment, the new parameter is under a new configuration such as CodebookConfig-r17 902. In yet another embodiment, the new parameter is a sub-parameter within the higher-layer parameter codebookType, whenever the Codebook Type is set to ‘typeII-PortSelection,’ ‘typeII-PortSelection-r16’ or another Type-II Port Selection Codebook, e.g., ‘typell-PortSelection-r17.’ An Example of the ASN. 1 code that corresponds to the last embodiment is provided in FIG. 4 for the CodebookConfig Codebook Configuration IE.

Due to the exploitation of the FDD reciprocity of the channel, a gNB may transmit beamformed CSI-RSs, where the CSI-RS beamforming is based on the UL channel estimated via SRS transmission. The beamforming can then flatten the channel in the frequency domain, i.e., a fewer number of significant channel taps, i.e., taps with relatively large power, are observed at the UE, compared with non-beamformed CSI-RS transmission. Such beamforming may result in a fewer number of coefficients, corresponding to fewer FD basis indices, being fed back in the CSI report.

In one embodiment, different codebook configurations related to the time-domain behavior of CSI reporting of reciprocity-based codebook, as well as the supporting uplink channels may be implemented. In addition, CSI-RS configurations that are associated with the aforementioned CSI reports corresponding to different time-domain behaviors and supporting uplink channels may be implemented. Different embodiments of this concept are provided below. Note that a combination of one or more features or elements of one embodiment with another is not precluded.

Regarding time-domain behavior of CSI reporting for reciprocity-based codebook, a UE is configured with a CSI Reporting Setting that triggers the UE to feed back a CSI report on an uplink channel with a specific time-domain behavior. In this section, different time-domain behaviors of CSI reporting for reciprocity-based codebook and supporting channels for the corresponding CSI reports are discussed. Different embodiments of this concept are provided below. Note that a combination of one or more features or elements of one embodiment with another is not precluded.

In a first embodiment, an aperiodic CSI report carried on the PUSCH supports wideband, and sub-band frequency granularities, wherein the aperiodic CSI report carried on the PUSCH supports or can be configured for/with Further Enhanced Type II CSI, e.g., Rel. 17 Type-II port selection codebook.

In a second embodiment, semi-persistent CSI reporting on the PUSCH supports Further Enhanced Type II CSI, e.g., Rel. 17 Type-II port selection codebook. In a first example, semi-persistent CSI reporting on the PUSCH supports Further Enhanced Type II CSI with codebook-based specific configuration.

In a third embodiment, periodic CSI reporting on PUCCH supports Further Enhanced Type II CSI, e.g., Rel. 17 Type-II port selection codebook. In a first example, periodic CSI reporting on PUCCH supports Further Enhanced Type II CSI with codebook-based specific configuration. In a second example, Further Enhanced Type II CSI is supported on periodic CSI reporting on/using PUCCH formats 3, 4.

In a fourth embodiment, semi-persistent CSI reporting on the PUCCH supports Further Enhanced Type II CSI, e.g., Rel. 17 Type-II port selection codebook. In a first example, semi-persistent CSI reporting on PUCCH supports Further Enhanced Type II CSI with codebook-based specific configuration. In a second example, Further Enhanced Type II CSI is supported on semi-persistent CSI reporting on PUCCH formats 3, 4.

In a fifth embodiment, Further Enhanced Type II CSI with codebook-based specific configuration corresponds to a codebook with at least one of the following configurations: wideband frequency granularity, and a PMI format indicator set to wideband, and a CQI format indicator set to wideband, and a number of PMI sub-bands per CQI sub-band set to a value below a certain threshold, e.g., 2, and a number of CSI-RS ports below a certain threshold, e.g., 16, and a number of beams below a certain threshold, e.g., 4, and a rank (number of layers) restricted to a specific value, e.g., 1, 2, and parameter corresponding to a number of selected frequency basis indices, e.g., M, set to one.

Regarding CSI-RS configuration for reciprocity-based codebook, a UE is configured with a CSI Reporting Setting that configures the UE to receive one or more NZP CSI-RS resources within a CSI-RS resource set for channel measurement. In this section we discuss the CSI resource setting corresponding to Rel. 17 Type-II port selection codebook. Different embodiments of this concept are provided below. Note that a combination of one or more features or elements of one embodiment with another is not precluded.

In a first embodiment, a UE configured with a higher-layer parameter for codebook type codebooktype set to a Further Enhanced Type II CSI, e.g., ‘typell-PortSelection-r17’ for a CSI Reporting Setting CSI-ReportConfig, is also expected to be configured with one or more NZP CSI-RS Resources with a CSI-RS frequency density in CSI-RS Resource mapping set to 0.25, e.g., ‘dot25’, within the same CSI Reporting Setting CSI-ReportConfig.

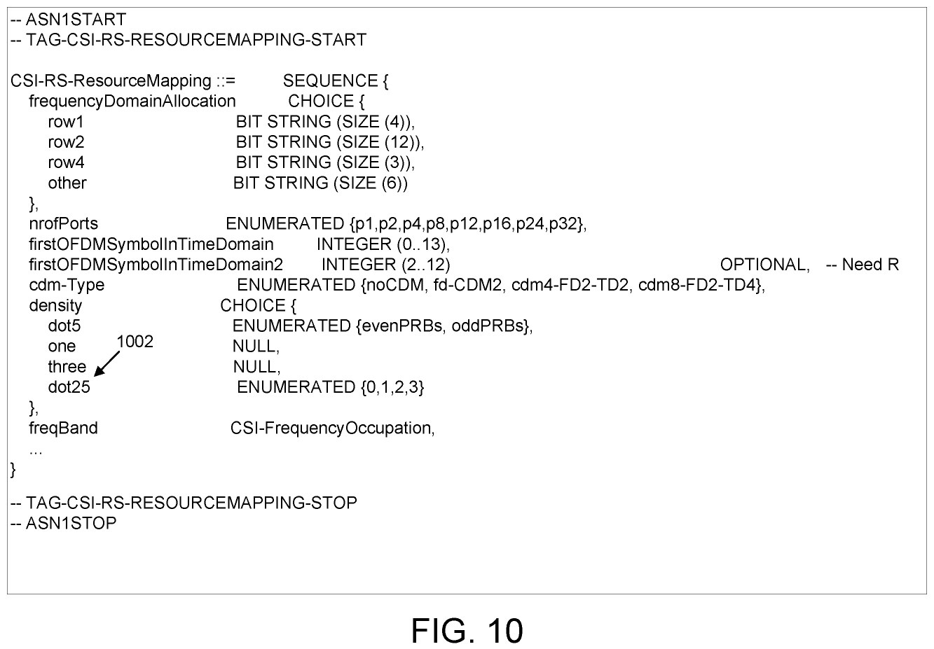

In a second embodiment, a CSI Reporting Setting with one or more NZP CSI-RS resources with a CSI-RS frequency density in CSI-RS Resource mapping configured with set to 0.25, e.g., ‘dot25’ 1002, includes a two-bit indication for RB level comb offset indicating whether the offset value is one of {0,1,2,3}. An example of the ASN. 1 code the corresponds to the CSI-ReportConfig Reporting Setting IE is provided in FIG. 10.

In a third embodiment, a UE is expected to be configured with one or more NZP CSI-RS Resources with a CSI-RS frequency density in CSI-RS Resource mapping set to 0.25, e.g., ‘dot25’, only if it is configured with a codebook configuration codebookConfig with a Further Enhanced Type II CSI codebook, e.g., ‘typeIl-PortSelection-r17’.

In a fourth embodiment, a UE is not expected to be configured with more than X CSI-RS resources in a CSI-RS resource set for channel measurement for a CSI-ReportConfig with the higher layer parameter codebookType set to a Further Enhanced Type II CSI codebook, e.g., ‘typeII-PortSelection-r17’. In one example, X=2.

In a fifth embodiment, a UE that is expected to send a CSI report corresponding to Further Enhanced Type II CSI, e.g., Rel. 17 Type-II port selection codebook, via one of periodic or semi-persistent reporting on PUCCH is also expected to be configured with an NZP CSI-RS Resource with a CSI-RS frequency density in CSI-RS Resource mapping set to 0.25, e.g., ‘dot25’.

In a sixth embodiment, a UE that is expected to send a CSI report corresponding to Further Enhanced Type II CSI, e.g., Rel. 17 Type-II port selection codebook, via one of periodic or semi-persistent reporting on PUCCH is also expected to be configured with two or more NZP CSI-RS Resources in a CSI-RS resource set for channel measurement for a CSI-ReportConfig Reporting Setting.

Regarding Antenna Panel/Port, Quasi-collocation, Transmission Configuration Indicator (“TCI”) state, and Spatial Relation, in some embodiments, the terms antenna, panel, and antenna panel are used interchangeably. An antenna panel may be a hardware that is used for transmitting and/or receiving radio signals at frequencies lower than 6GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna clement is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently. Unit of antenna group to control its transmission power independently. Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels.” In one implementation, the device may support UL transmission from one beam within a panel: with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located (“QCL”) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread }
‘QCL-TypeB’: { Doppler shift, Doppler spread }
‘QCL-TypeC’: {Doppler shift, average delay}
‘QCL-TypeD’: {Spatial Rx parameter}

Spatial Rx parameters may include one or more of: angle of arrival (“AoA”), Dominant AoA, average AoA, angular spread, Power Angular Spectrum (“PAS”) of AoA, average angle of departure (“AoD”), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mm Wave, FR2 and beyond), where essentially the UE may not be able to perform omni-directional transmission, i.e., the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

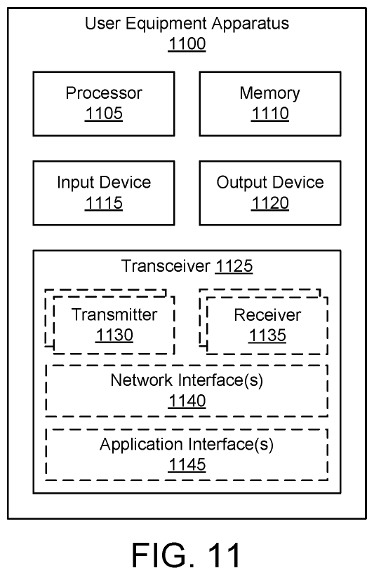

FIG. 11 depicts a user equipment apparatus 1100 that may be used for PUCCH

reporting of reciprocity-based Type-II codebook, according to embodiments of the disclosure. In various embodiments, the user equipment apparatus 1100 is used to implement one or more of the solutions described above. The user equipment apparatus 1100 may be one embodiment of a UE, such as the remote unit 105 and/or the UE 205, as described above. Furthermore, the user equipment apparatus 1100 may include a processor 1105, a memory 1110, an input device 1115, an output device 1120, and a transceiver 1125. In some embodiments, the input device 1115 and the output device 1120 are combined into a single device, such as a touchscreen. In certain embodiments, the user equipment apparatus 1100 may not include any input device 1115 and/or output device 1120. In various embodiments, the user equipment apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. Here, the transceiver 1125 communicates with one or more base units 121. Additionally, the transceiver 1125 may support at least one network interface 1140 and/or application interface 1145. The application interface(s) 1145 may support one or more APIs. The network interface(s) 1140 may support 3GPP reference points, such as Uu and PC5. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1105 executes instructions stored in the memory 1110 to perform the methods and routines described herein.

The processor 1105 is communicatively coupled to the memory 1110, the input device 1115, the output device 1120, and the transceiver 1125. In certain embodiments, the processor 1105 may include an application processor (also known as “main processor”) which manages application-domain and operating system (“OS”) functions and a baseband processor (also known as “baseband radio processor”) which manages radio functions. In various embodiments, the processor 1105 controls the user equipment apparatus 1100 to implement the above described UE behaviors for PUCCH reporting of reciprocity-based Type-II codebook.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to PUCCH reporting of reciprocity-based Type-II codebook. For example, the memory 1110 may store parameters, configurations, resource assignments, policies, and the like as described above. In certain embodiments, the memory 1110 also stores program code and related data, such as an operating system or other controller algorithms operating on the user equipment apparatus 1100, and one or more software applications.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, an LCD display, an LED display, an OLED display, a projector, or similar display device capable of outputting images, text, or the like to a user. As another, non-limiting, example, the output device 1120 may include a wearable display separate from, but communicatively coupled to, the rest of the user equipment apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (c.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 includes at least transmitter 1130 and at least one receiver 1135. The transceiver 1125 may be used to provide UL communication signals to a base unit 121 and to receive DL communication signals from the base unit 121, as described herein. Similarly, the transceiver 1125 may be used to transmit and receive sidelink (“SL”) signals (e.g., V2X communication). Although only one transmitter 1130 and one receiver 1135 are illustrated, the user equipment apparatus 1100 may have any suitable number of transmitters 1130 and receivers 1135. Further, the transmitter(s) 1130 and the receiver(s) 1135 may be any suitable type of transmitters and receivers. In one embodiment, the transceiver 1125 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1125, transmitters 1130, and receivers 1135 may be implemented as physically separate components that access a shared hardware resource and/or software resource, such as for example, the network interface 1140.

In various embodiments, one or more transmitters 1130 and/or one or more receivers 1135 may be implemented and/or integrated into a single hardware component, such as a multi-transceiver chip, a system-on-a-chip, an ASIC, or other type of hardware component. In certain embodiments, one or more transmitters 1130 and/or one or more receivers 1135 may be implemented and/or integrated into a multi-chip module. In some embodiments, other components such as the network interface 1140 or other hardware components/circuits may be integrated with any number of transmitters 1130 and/or receivers 1135 into a single chip. In such embodiment, the transmitters 1130 and receivers 1135 may be logically configured as a transceiver 1125 that uses one more common control signals or as modular transmitters 1130 and receivers 1135 implemented in the same hardware chip or in a multi-chip module.

In one embodiment, the transceiver 1125 receives, from a network entity, a channel state information (“CSI”) reporting configuration comprising a codebook type associated with a precoding matrix. In one embodiment, the transceiver 1125 receives, from the network entity, CSI reference signals (“CSI-RS”) over a set of CSI-RS resources based on the CSI reporting configuration. In one embodiment, the processor 1105 identifies a set of coefficients associated with the codebook based on the received set of CSI-RS resources. In one embodiment, the transceiver 1225 transmits, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration.

In one embodiment, the codebook type is indicated using a higher-layer parameter of a codebook configuration within the CSI reporting configuration.

In one embodiment, the CSI report is configured to be reported over the PUCCH.

In one embodiment, the transceiver 1125 transmits the CSI report based on one of periodic reporting and semi-persistent reporting.

In one embodiment, the CSI report is associated with one or more of a precoding matrix indicator (“PMI”) format indicator that is restricted to a value corresponding to a wideband format and a channel quality indicator (“CQI”) that is restricted to a value corresponding to a wideband format.

In one embodiment, a maximum configured value of a number of PMI sub-bands per CQI sub-band corresponding to the CSI report is less than a maximum configured value of a number of PMI sub-bands per CQI sub-band corresponding to a CSI report configured to be reported over the PUSCH.

In one embodiment, a maximum configured value of a rank of the codebook corresponding to the CSI report is less than a maximum configured value of a rank of the codebook corresponding to a CSI report configured to be reported over the PUSCH.

In one embodiment, the CSI report comprises PMI-based coefficients corresponding to at least one dimension corresponding to one or more frequency-domain basis indices.

In one embodiment, a maximum configured value of a number of frequency-domain basis indices corresponding to the CSI report is less than a maximum configured value of a number of frequency-domain basis indices corresponding to a CSI report configured to be reported over the PUSCH.

In one embodiment, the set of one or more non-zero power (“NZP”) CSI-RS resources for channel measurement is configured with frequency density of a value equal to one quarter.

In one embodiment, a CSI-RS resource mapping corresponding to the set of one or more NZP CSI-RS resources comprises an indication of a resource-block level offset, the resource-block level offset taking on values of 0, 1, 2, or 3.

In one embodiment, the set of one or more NZP CSI-RS resources for channel measurement configured with frequency density of a value equal to one quarter corresponds to CSI reporting on the PUCCH.

In one embodiment, the codebook type is a port-selection codebook.

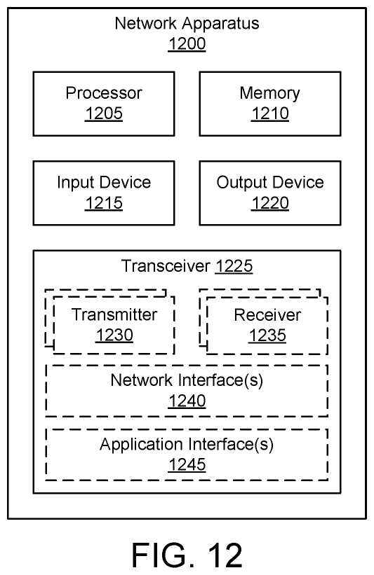

FIG. 12 depicts one embodiment of a network apparatus 1200 that may be used for PUCCH reporting of reciprocity-based Type-II codebook, according to embodiments of the disclosure. In some embodiments, the network apparatus 1200 may be one embodiment of a RAN node and its supporting hardware, such as the base unit 121 and/or the gNB 210, described above. Additionally, the network apparatus 1200 may include a processor 1205, a memory 1210, an input device 1215, an output device 1220, and a transceiver 1225. In certain embodiments, the network apparatus 1200 does not include any input device 1215 and/or output device 1220.

As depicted, the transceiver 1225 includes at least one transmitter 1230 and at least one receiver 1235. Here, the transceiver 1225 communicates with one or more remote units 65. Additionally, the transceiver 1225 may support at least one network interface 1240 and/or application interface 1245. The application interface(s) 1245 may support one or more APIs. The network interface(s) 1240 may support 3GPP reference points, such as Uu, S1, N1, N2, and/or N3 interfaces. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1205 executes instructions stored in the memory 1210 to perform the methods and routines described herein.

The processor 1205 is communicatively coupled to the memory 1210, the input device 1215, the output device 1220, and the transceiver 1225. In certain embodiments, the processor 1205 may include an application processor (also known as “main processor”) which manages application-domain and operating system (“OS”) functions and a baseband processor (also known as “baseband radio processor”) which manages radio function. In various embodiments, the processor 1205 controls the network apparatus 1200 to implement the above described network entity behaviors for PUCCH reporting of reciprocity-based Type-II codebook.

The memory 1210, in one embodiment, is a computer readable storage medium. In some embodiments, the memory 1210 includes volatile computer storage media. For example, the memory 1210 may include a RAM, including dynamic RAM (“DRAM”), synchronous dynamic RAM (“SDRAM”), and/or static RAM (“SRAM”). In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data relating to PUCCH reporting of reciprocity-based Type-II codebook. For example, the memory 1210 may store parameters, configurations, resource assignments, policies, and the like as described above. In certain embodiments, the memory 1210 also stores program code and related data, such as an operating system (“OS”) or other controller algorithms operating on the network apparatus 1200, and one or more software applications.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, may include any known electronically controllable display or display device. The output device 1220 may be designed to output visual, audible, and/or haptic signals. In some embodiments, the output device 1220 includes an electronic display capable of outputting visual data to a user. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all or portions of the output device 1220 may be integrated with the input device 1215. For example, the input device 1215 and output device 1220 may form a touchscreen or similar touch-sensitive display. In other embodiments, all or portions of the output device 1220 may be located near the input device 1215.

As discussed above, the transceiver 1225 may communicate with one or more remote units and/or with one or more interworking functions that provide access to one or more PLMNs. The transceiver 1225 may also communicate with one or more network functions (e.g., in the mobile core network 130). The transceiver 1225 operates under the control of the processor 1205 to transmit messages, data, and other signals and also to receive messages, data, and other signals. For example, the processor 1205 may selectively activate the transceiver (or portions thereof) at particular times in order to send and receive messages.

The transceiver 1225 may include one or more transmitters 1230 and one or more receivers 1235. In certain embodiments, the one or more transmitters 1230 and/or the one or more receivers 1235 may share transceiver hardware and/or circuitry. For example, the one or more transmitters 1230 and/or the one or more receivers 1235 may share antenna(s), antenna tuner(s), amplifier(s), filter(s), oscillator(s), mixer(s), modulator/demodulator(s), power supply, and the like. In one embodiment, the transceiver 1225 implements multiple logical transceivers using different communication protocols or protocol stacks, while using common physical hardware.

In one embodiment, the transceiver 1225 transmits, to a UE, a CSI reporting configuration comprising a codebook type associated with a precoding matrix. In one embodiment, the transceiver 1225 transmits, to the UE, CSI reference signals (“CSI-RS”) over a set of CSI-RS resources based on the CSI reporting configuration. In one embodiment, the transceiver 1225 receives, from the UE, a CSI report on a physical uplink control channel (“PUCCH”) or a physical uplink shared channel (“PUSCH”) and based on the codebook type, the CSI report comprising CSI and a set of coefficients associated with the codebook, wherein to receive the CSI report on the PUCCH is based on a value of a sub-configuration of the CSI reporting configuration.

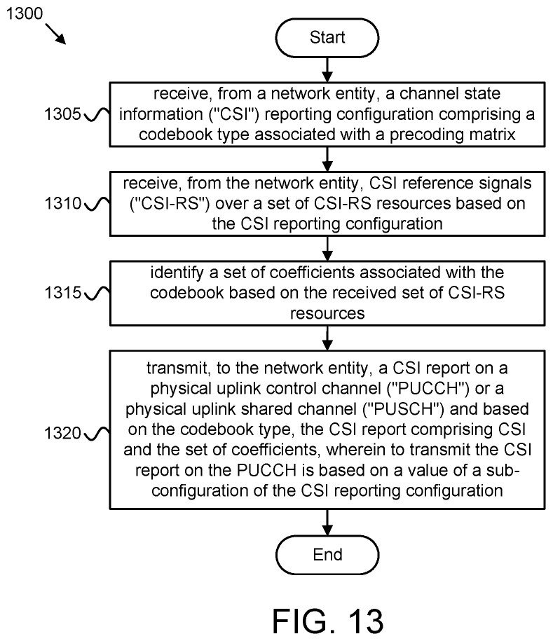

FIG. 13 is a flowchart diagram of a method 1300 for PUCCH reporting of reciprocity-based type-II codebook. The method 1300 may be performed by a user equipment device operating in a communication network, for example, the remote unit 105 and/or the user equipment apparatus 1100, described above. In some embodiments, the method 1300 may be performed by a processor executing program code, for example, a microcontroller, a microprocessor, a CPU, a GPU, an auxiliary processing unit, a FPGA, or the like.

In one embodiment, the method 1300 includes receiving 1305, from a network

entity, a channel state information (“CSI”) reporting configuration comprising a codebook type associated with a precoding matrix. In one embodiment, the method 1300 includes receiving 1310, from the network entity, CSI reference signals (“CSI-RS”) over a set of CSI-RS resources based on the CSI reporting configuration. In one embodiment, the method 1300 includes identifying 1315 a set of coefficients associated with the codebook based on the received set of CSI-RS resources. In one embodiment, the method 1300 includes transmitting 1320, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration, and the method 1300 ends.

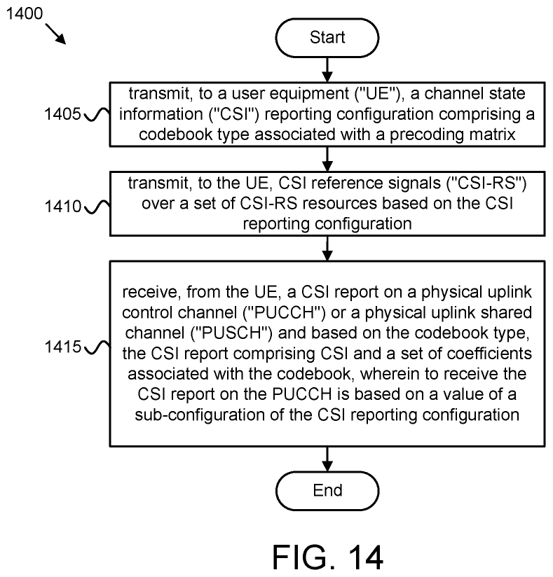

FIG. 14 is a flowchart diagram of a method 1300 for PUCCH reporting of reciprocity-based type-II codebook. The method 1400 may be performed a network equipment device operating in a communication network, for example, the access point 112, base unit 121, a gNB, and/or the network equipment apparatus 1200, described above. In some embodiments, the method 1400 may be performed by a processor executing program code, for example, a microcontroller, a microprocessor, a CPU, a GPU, an auxiliary processing unit, a FPGA, or the like.

In one embodiment, the method 1400 transmits 1405, to a user equipment (“UE”), a channel state information (“CSI”) reporting configuration comprising a codebook type associated with a precoding matrix. In one embodiment, the method 1400 transmits 1410, to the UE, CSI reference signals (“CSI-RS”) over a set of CSI-RS resources based on the CSI reporting configuration. In one embodiment, the method 1400 receives 1415, from the UE, a CSI report on a physical uplink control channel (“PUCCH”) or a physical uplink shared channel (“PUSCH”) and based on the codebook type, the CSI report comprising CSI and a set of coefficients associated with the codebook, wherein to receive the CSI report on the PUCCH is based on a value of a sub-configuration of the CSI reporting configuration, and the method 1400 ends.

A first apparatus is disclosed for PUCCH reporting of reciprocity-based type-II codebook. The first apparatus may include a user equipment device operating in a communication network, for example, the remote unit 105 and/or the user equipment apparatus 1100, described above. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver that receives, from a

network entity, a channel state information (“CSI”) reporting configuration comprising a codebook type associated with a precoding matrix. In one embodiment, the transceiver receives, from the network entity, CSI reference signals (“CSI-RS”) over a set of CSI-RS resources based on the CSI reporting configuration. In one embodiment, the apparatus includes a processor that identifies a set of coefficients associated with the codebook based on the received set of CSI-RS resources. In one embodiment, the transceiver transmits, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration.

In one embodiment, the codebook type is indicated using a higher-layer parameter of a codebook configuration within the CSI reporting configuration.

In one embodiment, the CSI report is configured to be reported over the PUCCH.

In one embodiment, the transceiver transmits the CSI report based on one of periodic reporting and semi-persistent reporting.

In one embodiment, the CSI report is associated with one or more of a precoding matrix indicator (“PMI”) format indicator that is restricted to a value corresponding to a wideband format and a channel quality indicator (“CQI”) that is restricted to a value corresponding to a wideband format.

In one embodiment, a maximum configured value of a number of PMI sub-bands per CQI sub-band corresponding to the CSI report is less than a maximum configured value of a number of PMI sub-bands per CQI sub-band corresponding to a CSI report configured to be reported over the PUSCH.

In one embodiment, a maximum configured value of a rank of the codebook corresponding to the CSI report is less than a maximum configured value of a rank of the codebook corresponding to a CSI report configured to be reported over the PUSCH.

In one embodiment, the CSI report comprises PMI-based coefficients corresponding to at least one dimension corresponding to one or more frequency-domain basis indices.

In one embodiment, a maximum configured value of a number of frequency-domain basis indices corresponding to the CSI report is less than a maximum configured value of a number of frequency-domain basis indices corresponding to a CSI report configured to be reported over the PUSCH.

In one embodiment, the set of one or more non-zero power (“NZP”) CSI-RS resources for channel measurement is configured with frequency density of a value equal to one quarter.

In one embodiment, a CSI-RS resource mapping corresponding to the set of one or more NZP CSI-RS resources comprises an indication of a resource-block level offset, the resource-block level offset taking on values of 0, 1, 2, or 3.

In one embodiment, the set of one or more NZP CSI-RS resources for channel measurement configured with frequency density of a value equal to one quarter corresponds to CSI reporting on the PUCCH.

In one embodiment, the codebook type is a port-selection codebook.

A first method is disclosed for PUCCH reporting of reciprocity-based type-II codebook. The first method may be performed by a user equipment device operating in a communication network, for example, the remote unit 105 and/or the user equipment apparatus 1100, described above. In some embodiments, the first method may be performed by a processor executing program code, for example, a microcontroller, a microprocessor, a CPU, a GPU, an auxiliary processing unit, a FPGA, or the like.

In one embodiment, the first method includes receiving, from a network entity, a channel state information (“CSI”) reporting configuration comprising a codebook type associated with a precoding matrix. In one embodiment, the first method includes receiving, from the network entity, CSI reference signals (“CSI-RS”) over a set of CSI-RS resources based on the CSI reporting configuration. In one embodiment, the first method includes identifying a set of coefficients associated with the codebook based on the received set of CSI-RS resources. In one embodiment, the first method includes transmitting, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration.

In one embodiment, the codebook type is indicated using a higher-layer parameter of a codebook configuration within the CSI reporting configuration.

In one embodiment, the CSI report is configured to be reported over the PUCCH.

In one embodiment, the first method transmits the CSI report based on one of periodic reporting and semi-persistent reporting.

In one embodiment, the CSI report is associated with one or more of a precoding matrix indicator (“PMI”) format indicator that is restricted to a value corresponding to a wideband format and a channel quality indicator (“CQI”) that is restricted to a value corresponding to a wideband format.

In one embodiment, a maximum configured value of a number of PMI sub-bands per CQI sub-band corresponding to the CSI report is less than a maximum configured value of a number of PMI sub-bands per CQI sub-band corresponding to a CSI report configured to be reported over the PUSCH.

In one embodiment, a maximum configured value of a rank of the codebook corresponding to the CSI report is less than a maximum configured value of a rank of the codebook corresponding to a CSI report configured to be reported over the PUSCH.

In one embodiment, the CSI report comprises PMI-based coefficients corresponding to at least one dimension corresponding to one or more frequency-domain basis indices.

In one embodiment, a maximum configured value of a number of frequency-domain basis indices corresponding to the CSI report is less than a maximum configured value of a number of frequency-domain basis indices corresponding to a CSI report configured to be reported over the PUSCH.

In one embodiment, the set of one or more non-zero power (“NZP”) CSI-RS resources for channel measurement is configured with frequency density of a value equal to one quarter.

In one embodiment, a CSI-RS resource mapping corresponding to the set of one or more NZP CSI-RS resources comprises an indication of a resource-block level offset, the resource-block level offset taking on values of 0, 1, 2, or 3.

In one embodiment, the set of one or more NZP CSI-RS resources for channel measurement configured with frequency density of a value equal to one quarter corresponds to CSI reporting on the PUCCH.

In one embodiment, the codebook type is a port-selection codebook.

A second apparatus is disclosed for PUCCH reporting of reciprocity-based type-II codebook. The second apparatus may include a network equipment device operating in a communication network, for example, the access point 112, base unit 121, a gNB, and/or the network equipment apparatus 1200, described above. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver that transmits, to a user equipment (“UE”), a channel state information (“CSI”) reporting configuration comprising a codebook type associated with a precoding matrix. In one embodiment, the transceiver transmits, to the UE, CSI reference signals (“CSI-RS”) over a set of CSI-RS resources based on the CSI reporting configuration. In one embodiment, the transceiver receives, from the UE, a CSI report on a physical uplink control channel (“PUCCH”) or a physical uplink shared channel (“PUSCH”) and based on the codebook type, the CSI report comprising CSI and a set of coefficients associated with the codebook, wherein to receive the CSI report on the PUCCH is based on a value of a sub-configuration of the CSI reporting configuration.

A second method is disclosed for PUCCH reporting of reciprocity-based type-II codebook. The second method may be performed a network equipment device operating in a communication network, for example, the access point 112, base unit 121, a gNB, and/or the network equipment apparatus 1200, described above. In some embodiments, the second method may be performed by a processor executing program code, for example, a microcontroller, a microprocessor, a CPU, a GPU, an auxiliary processing unit, a FPGA, or the like.

In one embodiment, the second method transmits, to a user equipment (“UE”), a channel state information (“CSI”) reporting configuration comprising a codebook type associated with a precoding matrix. In one embodiment, the second method transmits, to the UE, CSI reference signals (“CSI-RS”) over a set of CSI-RS resources based on the CSI reporting configuration. In one embodiment, the second method receives, from the UE, a CSI report on a physical uplink control channel (“PUCCH”) or a physical uplink shared channel (“PUSCH”) and based on the codebook type, the CSI report comprising CSI and a set of coefficients associated with the codebook, wherein to receive the CSI report on the PUCCH is based on a value of a sub-configuration of the CSI reporting configuration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) apparatus for channel state information (“CSI”) reporting, the apparatus comprising:
a transceiver that:
receives, from a network entity, a channel state information (“CSI”) reporting configuration comprising a codebook type associated with a precoding matrix; and
receives, from the network entity, CSI reference signals (“CSI-RS”) over a set of CSI-RS resources based on the CSI reporting configuration; and
a processor that identifies a set of coefficients associated with the codebook based on the received set of CSI-RS resources,
wherein the transceiver transmits, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration.

2. The apparatus of claim 1, wherein the codebook type is indicated using a higher-layer parameter of a codebook configuration within the CSI reporting configuration.

3. The apparatus of claim 1, wherein the CSI report is configured to be reported over the PUCCH.

4. The apparatus of claim 3, wherein the transceiver transmits the CSI report based on one of periodic reporting and semi-persistent reporting.

5. The apparatus of claim 3, wherein the CSI report is associated with one or more of:
a precoding matrix indicator (“PMI”) format indicator that is restricted to a value corresponding to a wideband format; or
a channel quality indicator (“CQI”) that is restricted to a value corresponding to a wideband format.

6. The apparatus of claim 3, wherein a maximum configured value of a number of PMI sub-bands per CQI sub-band corresponding to the CSI report is less than a maximum configured value of a number of PMI sub-bands per CQI sub-band corresponding to a CSI report configured to be reported over the PUSCH.

7. The apparatus of claim 3, wherein a maximum configured value of a rank of the codebook corresponding to the CSI report is less than a maximum configured value of a rank of the codebook corresponding to a CSI report configured to be reported over the PUSCH.

8. The apparatus of claim 3, wherein the CSI report comprises PMI-based coefficients corresponding to at least one dimension corresponding to one or more frequency-domain basis indices.

9. The apparatus of claim 8, wherein a maximum configured value of a number of frequency-domain basis indices corresponding to the CSI report is less than a maximum configured value of a number of frequency-domain basis indices corresponding to a CSI report configured to be reported over the PUSCH.

10. The apparatus of claim 1, wherein the set of one or more non-zero power (“NZP”) CSI-RS resources for channel measurement is configured with frequency density of a value equal to one quarter.

11. The apparatus of claim 10, wherein a CSI-RS resource mapping corresponding to the set of one or more NZP CSI-RS resources comprises an indication of a resource-block level offset, the resource-block level offset taking on values of 0, 1, 2, or 3.

12. The apparatus of claim 10, wherein the set of one or more NZP CSI-RS resources for channel measurement configured with frequency density of a value equal to one quarter corresponds to CSI reporting on the PUCCH.

13. The apparatus of claim 1, wherein the codebook type is a port-selection codebook.

14. A network entity apparatus for channel state information (“CSI”) reporting, the apparatus comprising:
a transceiver that:
transmits, to a user equipment (“UE”), a channel state information (“CSI”) reporting configuration comprising a codebook type associated with a precoding matrix;
transmits, to the UE, CSI reference signals (“CSI-RS”) over a set of CSI-RS resources based on the CSI reporting configuration; and
receives, from the UE, a CSI report on a physical uplink control channel (“PUCCH”) or a physical uplink shared channel (“PUSCH”) and based on the codebook type, the CSI report comprising CSI and a set of coefficients associated with the codebook, wherein to receive the CSI report on the PUCCH is based on a value of a sub-configuration of the CSI reporting configuration.

15. A method of a user equipment (“UE”) for channel state information (“CSI”) reporting, the method comprising:
receiving, from a network entity, a channel state information (“CSI”) reporting configuration comprising a codebook type associated with a precoding matrix;
receiving, from the network entity, CSI reference signals (“CSI-RS”) over a set of CSI-RS resources based on the CSI reporting configuration;
identifying a set of coefficients associated with the codebook based on the received set of CSI-RS resources; and
transmitting, to the network entity, a CSI report on a physical uplink control channel (“PUCCH”) or a physical uplink shared channel (“PUSCH”) and based on the codebook type, the CSI report comprising CSI and the set of coefficients, wherein to transmit the CSI report on the PUCCH is based on a value of a sub-configuration of the CSI reporting configuration.

16. A processor for channel state information (“CSI”) reporting in a user equipment (“UE”), the processor comprising:
at least one controller coupled with at least one memory and configured to cause the UE to:
receive, from a network entity, a channel state information (“CSI”) reporting configuration comprising a codebook type associated with a precoding matrix;
receive, from the network entity, CSI reference signals (“CSI-RS”) over a set of CSI-RS resources based on the CSI reporting configuration; and
identify a set of coefficients associated with the codebook based on the received set of CSI-RS resources, and
transmit, to the network entity, a CSI report on a physical uplink control channel (“PUCCH”) or a physical uplink shared channel (“PUSCH”), and based on the codebook type, the CSI report comprising CSI and the set of coefficients, wherein to transmit the CSI report on the PUCCH is based on a value of a sub-configuration of the CSI reporting configuration.

17. The processor of claim 16, wherein the CSI report is configured to be reported over the PUCCH.

18. The processor of claim 17, wherein the UE transmits the CSI report based on one of periodic reporting and semi-persistent reporting.

19. The processor of claim 17, wherein the CSI report is associated with one or more of:
a precoding matrix indicator (“PMI”) format indicator that is restricted to a value corresponding to a wideband format; or
a channel quality indicator (“CQI”) that is restricted to a value corresponding to a wideband format.

20. The processor of claim 17, wherein a maximum configured value of a number of PMI sub-bands per CQI sub-band corresponding to the CSI report is less than a maximum configured value of a number of PMI sub-bands per CQI sub-band corresponding to a CSI report configured to be reported over the PUSCH.
